(19) United States
(12) Patent Application Publication
(10) Pub. No.: US 2022/0014774 A1
(43) Pub. Date: Jan. 13, 2022

(54) VIDEO ENCODING AND DECODING METHOD USING TILES AND TILE GROUPS, AND VIDEO ENCODING AND DECODING DEVICE USING TILES AND TILE GROUPS

(71) Applicant: SAMSUNG ELECTRONICS CO., LTD., Suwon-si (KR)

(72) Inventors: Woongil CHOI, Suwon-si (KR); Gahyun RYU, Suwon-si (KR); Minsoo PARK, Suwon-si (KR); Minwoo PARK, Suwon-si (KR); Yumi SOHN, Suwon-si (KR); Seungsoo JEONG, Suwon-si (KR); Narae CHOI, Suwon-si (KR); Anish TAMSE, Suwon-si (KR)

(73) Assignee: SAMSUNG ELECTRONICS CO., LTD., Suwon-si (KR)

(21) Appl. No.: 17/283,470

(22) PCT Filed: Oct. 11, 2019
(86) PCT No.: PCT/KR2019/013390

§ 371 Date: Apr. 7, 2021

Related U.S. Application Data
(60) Provisional application No. 62/744,172, filed on Oct. 11, 2018.

(51) Int. Cl. H04N 19/513; H04N 19/139; H04N 19/176; H04N 19/119; H04N 19/172; H04N 19/117; H04N 19/109

(52) U.S. Cl. CPC H04N 19/513; H04N 19/139; H04N 19/176; H04N 19/109; H04N 19/172; H04N 19/117; H04N 19/119

(57) ABSTRACT

Provided is a video decoding method including: determining whether or not to perform history-based motion vector prediction for inter-prediction of a current block, based on a location of the current block in a tile including a plurality of largest coding units; when it is determined to perform the history-based motion vector prediction on the current block, generating a motion information candidate list including history-based motion vector candidates; determining a motion vector of the current block by using a motion vector predictor determined from the motion information candidate list; and reconstructing the current block by using the motion vector of the current block, wherein, when a motion constraint is applied to a first tile group, when a reference picture of a first tile from among tiles included in the first tile group is a second picture, a motion vector of the first tile is not permitted to indicate a block of the second picture, the block being located outside a second tile group, and when the motion constraint is not applied to the first tile group, the motion vector of the first tile is permitted to indicate the block of the second picture, the block being located outside the second tile group.

### TECHNICAL FIELD

The present disclosure relates to the fields of image encoding and decoding. In detail, the present disclosure relates to a method and apparatus for encoding and decoding an image by splitting the image into tiles and tile groups.

### BACKGROUND ART

Data-level parallelism refers to a method, whereby data to be processed by a parallelizing program is split into various units, and the various units of split data are assigned to different cores or threads, so that the same operations are performed in a parallel manner. For example, a picture of an input video may be split into four slices, and then, the split slices may be assigned to different cores, so that encoding/decoding operations are performed in parallel. In addition to units of a slice, a video may be split into data of various units, such as units of a group of pictures (GOP), units of a frame, units of a macroblock, and units of a block. Thus, data-level parallelism may further be specified as various techniques according to the units in which the video data is split. Among various techniques, parallelism techniques in the units of a frame, a slice, and a macroblock are frequently used in data-level parallelism of a video encoder and a video decoder. The data-level parallelism performs parallelism after splitting data such that there is no inter-dependency between the split data, and thus, the amount of data movement between assigned cores or threads may be small. Also, generally, data may be split according to the number of cores.

In high efficiency video coding (HEVC), tiles have been introduced as a parallelism technique. Tiles may have only a rectangular shape, unlike a previous slice splitting method. Also, the tiles may reduce deterioration in the encoding performance, compared to splitting of a picture into the same number of slices.

### DESCRIPTION OF EMBODIMENTS

### Technical Problem

According to an embodiment, provided are efficient encoding and decoding of a picture that is split into tiles or tile groups.

### Solution to Problem

A method of decoding a motion vector, according to an embodiment of the present disclosure, includes: determining whether or not to perform history-based motion vector prediction for inter-prediction of a current block, based on a location of the current block in a tile including a plurality of largest coding units; when it is determined to perform the history-based motion vector prediction on the current block, generating a motion information candidate list including history-based motion vector candidates; determining a motion vector of the current block by using a motion vector predictor determined from the motion information candidate list; and reconstructing the current block by using the motion vector of the current block.

### Advantageous Effects of Disclosure

According to an encoding method and a decoding method, and an encoding apparatus and a decoding apparatus, the encoding and decoding methods and the encoding and decoding apparatuses using tiles and pictures, according to an embodiment, the pictures may be effectively encoded and decoded by expanding a prediction range of data in the pictures while maintaining non-dependency of data encoding between the tiles.

However, effects achievable by the encoding method and the decoding method, and the encoding apparatus and the decoding apparatus, the encoding and decoding methods and the encoding and decoding apparatuses using tiles and pictures, according to an embodiment, are not limited to those mentioned above, and other effects that are not mentioned could be clearly understood by one of ordinary skill in the art from the following description.

### BRIEF DESCRIPTION OF DRAWINGS

A brief description of each drawing is provided to better understanding of the drawings cited herein.

FIG. 1 is a schematic block diagram of an image decoding apparatus according to an embodiment.

FIG. 2 is a flowchart of an image decoding method according to an embodiment.

FIG. 3 illustrates a process, performed by an image decoding apparatus, of determining at least one coding unit by splitting a current coding unit, according to an embodiment.

FIG. 4 illustrates a process, performed by an image decoding apparatus, of determining at least one coding unit by splitting a non-square coding unit, according to an embodiment.

FIG. 5 illustrates a process, performed by an image decoding apparatus, of splitting a coding unit based on at least one of block shape information and split shape mode information, according to an embodiment.

FIG. 6 illustrates a method, performed by an image decoding apparatus, of determining a certain coding unit from among an odd number of coding units, according to an embodiment.

FIG. 7 illustrates an order of processing a plurality of coding units when an image decoding apparatus determines the plurality of coding units by splitting a current coding unit, according to an embodiment.

FIG. 8 illustrates a process, performed by an image decoding apparatus, of determining that a current coding unit is to be split into an odd number of coding units, when the coding units are not processable in a certain order, according to an embodiment.

FIG. 9 illustrates a process, performed by an image decoding apparatus, of determining at least one coding unit by splitting a first coding unit, according to an embodiment.

FIG. 10 illustrates that a shape into which a second coding unit is splittable is restricted when the second coding unit having a non-square shape, which is determined when an image decoding apparatus splits a first coding unit, satisfies a certain condition, according to an embodiment.

FIG. 11 illustrates a process, performed by an image decoding apparatus, of splitting a square coding unit when split shape mode information is unable to indicate that the square coding unit is split into four square coding units, according to an embodiment.

FIG. 12 illustrates that a processing order between a plurality of coding units may be changed depending on a process of splitting a coding unit, according to an embodiment.

FIG. 13 illustrates a process of determining a depth of a coding unit when a shape and size of the coding unit change, when the coding unit is recursively split such that a plurality of coding units are determined, according to an embodiment.

FIG. 14 illustrates depths that are determinable based on shapes and sizes of coding units, and part indexes (PIDs) that are for distinguishing the coding units, according to an embodiment.

FIG. 15 illustrates that a plurality of coding units are determined based on a plurality of certain data units included in a picture, according to an embodiment.

FIG. 16 is a block diagram of an image encoding and decoding system.

FIG. 17 is a detailed block diagram of a video decoding apparatus according to an embodiment.

FIG. 18 is a flowchart of a video decoding method according to an embodiment.

FIG. 19 is a block diagram of a video encoding apparatus according to an embodiment.

FIG. 20 is a flowchart of a video encoding method according to an embodiment.

FIGS. 21 and 22 illustrate a relationship among a largest coding unit, a tile, and a slice in a tile-partitioning method according to an embodiment.

FIG. 23 illustrates a picture split into tiles of various coding types, according to an embodiment.

FIG. 24 illustrates a limit range of motion compensation, according to an embodiment.

FIG. 25 illustrates a cropping window for each tile, according to an embodiment.

FIG. 26 illustrates a relationship between a largest coding unit and a tile in a tile-partitioning method according to another embodiment.

FIGS. 27 and 28 illustrate an address assignment method of a largest coding unit included in tiles, in a tile partitioning method according to another embodiment.

### BEST MODE

A method of decoding motion information, according to an embodiment of the present disclosure, includes: determining whether or not to perform history-based motion vector prediction for inter-prediction of a current block, based on a location of the current block in a tile including a plurality of largest coding units; when it is determined to perform the history-based motion vector prediction on the current block, generating a motion information candidate list including history-based motion vector candidates; determining a motion vector of the current block by using a motion vector predictor determined from the motion information candidate list; and reconstructing the current block by using the motion vector of the current block.

In the method of decoding motion information, according to an embodiment, a picture may be split into one or more tile rows and one or more tile columns, the tile may be a square area including one or more largest coding units split from the picture, and the tile may be included in the one or more tile rows and the one or more tile columns.

In the method of decoding motion information, according to an embodiment, when the current block is a first block of the tile, a number of history-based motion vector candidates for the inter-prediction of the current block may be reset to 0.

In the method of decoding motion information, according to an embodiment, a first tile group may include a plurality of neighboring tiles from among tiles split from a first picture, and a second tile group may include tiles of a second picture, the tiles corresponding to locations of the tiles included in the first tile group, and when a motion constraint is applied to the first tile group, when a reference picture of a first tile from among the tiles included in the first tile group is the second picture, a motion vector of the first tile may indicate a block included in the tiles included in the second tile group and may not be permitted to indicate a block of the second picture, the block being located outside the second tile group.

In the method of decoding motion information, according to an embodiment, when a motion constraint is not applied to the first tile group, a motion vector of a first tile may be permitted to indicate a block of the second picture, the block being located outside the second tile group.

In the method of decoding motion information, according to an embodiment, the picture may be split into one or more tile groups, and whether or not to perform in-loop filtering on a boundary of the one or more tile groups may be determined.

In the method of decoding motion information, according to an embodiment, coding types of tiles split from the picture may be one of I-type, P-type, and B-type, the coding types of the tiles may be independently determined, and a tile group randomly accessible and a tile group not randomly accessible may be separately determined from among the tiles.

In the method of decoding motion information, according to an embodiment, a first tile group may include a plurality of neighboring tiles from among tiles split from a first picture, and a second tile group may include tiles of a second picture, the tiles corresponding to locations of the tiles included in the first tile group, and when a reference picture of a first tile from among the tiles included in the first tile group is the first picture, a motion vector of the first tile may indicate a block included in the tiles included in the second tile group and may not be permitted to indicate a block of the second picture, the block being located outside the second tile group.

An apparatus for decoding motion information, according to an embodiment of the present disclosure, includes: a block location determiner configured to determine whether or not to perform history-based motion vector prediction for inter-prediction of a current block, based on a location of the current block in a tile including a plurality of largest coding units; an inter-prediction performer configured to generate a motion information candidate list including history-based motion vector candidates, when it is determined to perform the history-based motion vector prediction on the current block, and configured to determine a motion vector of the current block by using a motion vector predictor determined from the motion information candidate list; and a reconstructor configured to reconstruct the current block by using the motion vector of the current block.

In the apparatus for decoding motion information according to an embodiment, a first tile group may include a plurality of neighboring tiles from among tiles split from a first picture, and a second tile group may include tiles of a second picture, the tiles corresponding to locations of the tiles included in the first tile group, when a motion constraint is applied to the first tile group, when a reference picture of a first tile from among the tiles included in the first tile group is the second picture, a motion vector of the first tile may indicate a block included in the tiles included in the second tile group and may not be permitted to indicate a block of the second picture, the block being located outside the second tile group, and when the motion constraint is not applied to the first tile group, the motion vector of the first tile may be permitted to indicate the block of the second picture, the block being located outside the second tile group.

In the apparatus for decoding motion information according to an embodiment, a picture may be split into one or more tile groups, and whether or not to perform in-loop filtering on a boundary of the one or more tile groups may be determined.

In the apparatus for decoding motion information according to an embodiment, a picture may be split into a plurality of tiles including the current tile, coding types of the tiles split from the picture may be one of I-type, P-type, and B-type, the coding types of the tiles may be independently determined, and a tile group for which a random-access point is possible and a tile group for which a random-access point is not possible may be separately determined from among the tiles.

A method of encoding motion information, according to an embodiment of the present disclosure, includes: determining whether or not to perform history-based motion vector prediction for inter-prediction of a current block, based on a location of the current block in a tile including a plurality of largest coding units; when it is determined to perform the history-based motion vector prediction on the current block, generating a motion information candidate list including history-based motion vector candidates; determining a motion vector of the current block; and encoding a candidate index indicating a motion vector candidate for predicting the motion vector of the current block, from the motion information candidate list.

In the method of encoding the motion formation according to an embodiment, a first tile group may include a plurality of neighboring tiles from among tiles split from a first picture, and a second tile group may include tiles of a second picture, the tiles corresponding to locations of the tiles included in the first tile group, when a motion constraint is applied to the first tile group, when a reference picture of a first tile from among the tiles included in the first tile group is the second picture, a motion vector of the first tile may indicate a block included in the tiles included in the second tile group and may not be permitted to indicate a block of the second picture, the block being located outside the second tile group, and when the motion constraint is not applied to the first tile group, the motion vector of the first tile may be permitted to indicate the block of the second picture, the block being located outside the second tile group.

In the method of encoding the motion formation according to an embodiment, a picture may be split into a plurality of tiles including the current tile, coding types of the tiles split from the picture may be one of I-type, P-type, and B-type, the coding types of the tiles may be independently determined, and a tile group for which a random-access point is possible and a tile group for which a random-access point is not possible may be separately determined from among the tiles.

An apparatus for encoding motion information, according to an embodiment of the present disclosure, includes: a block location determiner configured to determine whether or not to perform history-based motion vector prediction for inter-prediction of a current block, based on a location of the current block in a tile including a plurality of largest coding units; an inter-prediction performer configured to generate a motion information candidate list including history-based motion vector candidates, when it is determined to perform the history-based motion vector prediction on the current block, and configured to determine a motion vector of the current block; and an entropy encoder configured to encode a candidate index indicating a motion vector candidate for predicting the motion vector of the current block, from the motion information candidate list.

A computer-readable recording medium according to an embodiment of the present disclosure may have recorded thereon a program for executing a video decoding method on a computer.

A computer-readable recording medium according to an embodiment of the present disclosure may have recorded thereon a program for executing a video encoding method on a computer.

### MODE OF DISCLOSURE

As the present disclosure allows for various changes and numerous examples, particular embodiments will be illustrated in the drawings and described in detail in the written description. However, this is not intended to limit the present disclosure to particular modes of practice, and it will be understood that all changes, equivalents, and substitutes that do not depart from the spirit and technical scope of various embodiments are encompassed in the present disclosure.

In the description of embodiments, certain detailed explanations of related art are omitted when it is deemed that they may unnecessarily obscure the essence of the present disclosure. Also, numbers (for example, a first, a second, and the like) used in the description of the specification are merely identifier codes for distinguishing one element from another.

Also, in the present specification, it will be understood that when elements are “connected” or “coupled” to each other, the elements may be directly connected or coupled to each other, but may alternatively be connected or coupled to each other with an intervening element therebetween, unless specified otherwise.

In the present specification, regarding an element represented as a “unit” or a “module”, two or more elements may be combined into one element or one element may be divided into two or more elements according to subdivided functions. In addition, each element described hereinafter may additionally perform some or all of functions performed by another element, in addition to main functions of itself, and some of the main functions of each element may be performed entirely by another component.

Also, in the present specification, an ‘image’ or a ‘picture’ may denote a still image of a video or a moving image, i.e., the video itself.

Also, in the present specification, a ‘sample’ denotes data assigned to a sampling position of an image, i.e., data to be processed. For example, pixel values of an image in a spatial domain and transform coefficients on a transform region may be samples. A unit including at least one such sample may be defined as a block.

Also, in the present specification, a ‘current block’ may denote a block of a largest coding unit, coding unit, prediction unit, or transform unit of a current image to be encoded or decoded.

In the present specification, a motion vector in a list 0 direction may denote a motion vector used to indicate a block in a reference picture included in a list 0, and a motion vector in a list 1 direction may denote a motion vector used to indicate a block in a reference picture included in a list 1. Also, a motion vector in a unidirection may denote a motion vector used to indicate a block in a reference picture included in a list 0 or list 1, and a motion vector in a bidirection may denote that the motion vector includes a motion vector in a list 0 direction and a motion vector in a list 1 direction.

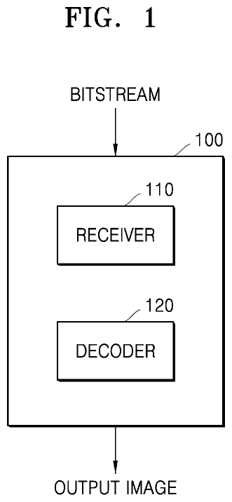

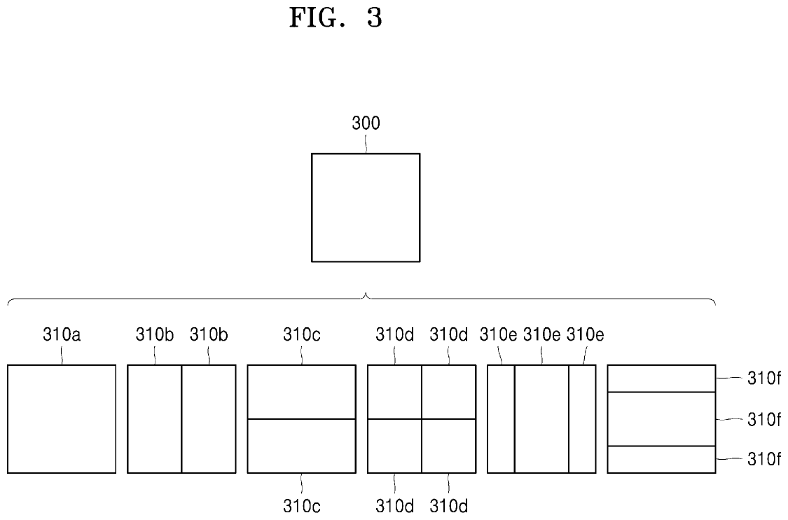

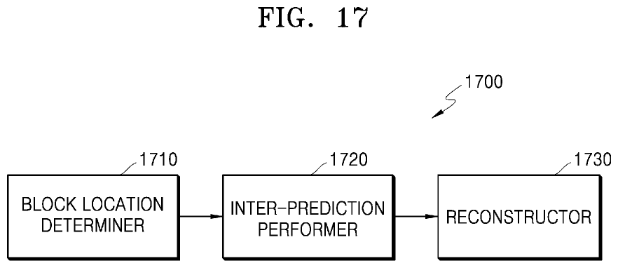

Hereinafter, an image encoding apparatus and an image decoding apparatus, and an image encoding method and an image decoding method, according to embodiments, will be described with reference to FIGS. 1 through 16. A method of determining a data unit of an image, according to an embodiment, will be described with reference to FIGS. 3 through 16, and a video encoding/decoding method using tiles and tile groups according to an embodiment will be described with reference to FIGS. 17 through 28.

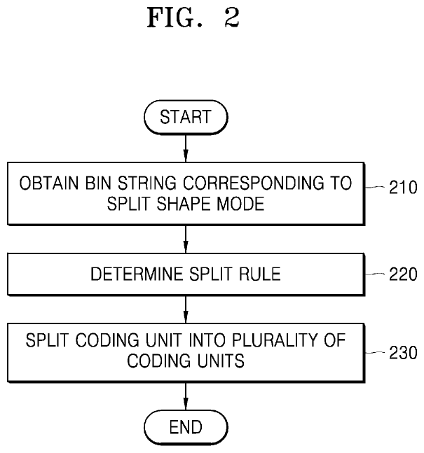

Hereinafter, a method and apparatus for adaptive selection based on various shapes of coding units, according to an embodiment of the present disclosure, will be described with reference to FIGS. 1 and 2.

FIG. 1 is a schematic block diagram of an image decoding apparatus according to an embodiment.

An image decoding apparatus 100 may include a receiver 110 and a decoder 120. The receiver 110 and the decoder 120 may include at least one processor. Also, the receiver 110 and the decoder 120 may include a memory storing instructions to be performed by the at least one processor.

The receiver 110 may receive a bitstream. The bitstream includes information of an image encoded by an image encoding apparatus 2200 described later. Also, the bitstream may be transmitted from the image encoding apparatus 2200. The image encoding apparatus 2200 and the image decoding apparatus 100 may be connected by wire or wirelessly, and the receiver 110 may receive the bitstream by wire or wirelessly. The receiver 110 may receive the bitstream from a storage medium, such as an optical medium or a hard disk. The decoder 120 may reconstruct an image based on information obtained from the received bitstream. The decoder 120 may obtain, from the bitstream, a syntax element for reconstructing the image. The decoder 120 may reconstruct the image based on the syntax element.

Operations of the image decoding apparatus 100 will be described in detail with reference to FIG. 2.

FIG. 2 is a flowchart of an image decoding method according to an embodiment.

According to an embodiment of the present disclosure, the receiver 110 receives a bitstream.

The image decoding apparatus 100 obtains, from a bitstream, a bin string corresponding to a split shape mode of a coding unit (operation 210). The image decoding apparatus 100 determines a split rule of the coding unit (operation 220). Also, the image decoding apparatus 100 splits the coding unit into a plurality of coding units, based on at least one of the bin string corresponding to the split shape mode and the split rule (operation 230). The image decoding apparatus 100 may determine an allowable first range of a size of the coding unit, according to a ratio of the width and the height of the coding unit, so as to determine the split rule. The image decoding apparatus 100 may determine an allowable second range of the size of the coding unit, according to the split shape mode of the coding unit, so as to determine the split rule.

Hereinafter, splitting of a coding unit will be described in detail according to an embodiment of the present disclosure.

First, one picture may be split into one or more slices or one or more tiles. One slice or one tile may be a sequence of one or more largest coding units (coding tree units (CTUs)). There is a largest coding block (coding tree block (CTB)) conceptually compared to a largest coding unit (CTU).

The largest coding unit (CTB) denotes an N×N block including N×N samples (N is an integer). Each color component may be split into one or more largest coding blocks.

When a picture has three sample arrays (sample arrays for Y, Cr, and Cb components), a largest coding unit (CTU) includes a largest coding block of a luma sample, two corresponding largest coding blocks of chroma samples, and syntax structures used to encode the luma sample and the chroma samples. When a picture is a monochrome picture, a largest coding unit includes a largest coding block of a monochrome sample and syntax structures used to encode the monochrome samples. When a picture is a picture encoded in color planes separated according to color components, a largest coding unit includes syntax structures used to encode the picture and samples of the picture.

One largest coding block (CTB) may be split into M×N coding blocks including M×N samples (M and N are integers).

When a picture has sample arrays for Y, Cr, and Cb components, a coding unit (CU) includes a coding block of a luma sample, two corresponding coding blocks of chroma samples, and syntax structures used to encode the luma sample and the chroma samples. When a picture is a monochrome picture, a coding unit includes a coding block of a monochrome sample and syntax structures used to encode the monochrome samples. When a picture is a picture encoded in color planes separated according to color components, a coding unit includes syntax structures used to encode the picture and samples of the picture.

As described above, a largest coding block and a largest coding unit are conceptually distinguished from each other, and a coding block and a coding unit are conceptually distinguished from each other. That is, a (largest) coding unit refers to a data structure including a (largest) coding block including a corresponding sample and a syntax structure corresponding to the (largest) coding block. However, because it is understood by one of ordinary skill in the art that a (largest) coding unit or a (largest) coding block refers to a block of a certain size including a certain number of samples, a largest coding block and a largest coding unit, or a coding block and a coding unit are mentioned in the following specification without being distinguished unless otherwise described.

An image may be split into largest coding units (CTUs). A size of each largest coding unit may be determined based on information obtained from a bitstream. A shape of each largest coding unit may be a square shape of the same size. However, an embodiment is not limited thereto.

For example, information about a maximum size of a luma coding block may be obtained from a bitstream. For example, the maximum size of the luma coding block indicated by the information about the maximum size of the luma coding block may be one of 4×4, 8×8, 16×16, 32×32, 64×64, 128×128, and 256×256.

For example, information about a luma block size difference and a maximum size of a luma coding block that may be split into two may be obtained from a bitstream. The information about the luma block size difference may refer to a size difference between a luma largest coding unit and a largest luma coding block that may be split into two. Accordingly, when the information about the maximum size of the luma coding block that may be split into two and the information about the luma block size difference obtained from the bitstream are combined with each other, a size of the luma largest coding unit may be determined. A size of a chroma largest coding unit may be determined by using the size of the luma largest coding unit. For example, when a Y:Cb:Cr ratio is 4:2:0 according to a color format, a size of a chroma block may be half a size of a luma block, and a size of a chroma largest coding unit may be half a size of a luma largest coding unit.

According to an embodiment, because information about a maximum size of a luma coding block that is binary splittable is obtained from a bitstream, the maximum size of the luma coding block that is binary splittable may be variably determined. In contrast, a maximum size of a luma coding block that is ternary splittable may be fixed. For example, the maximum size of the luma coding block that is ternary splittable in an I-picture may be 32×32, and the maximum size of the luma coding block that is ternary splittable in a P-picture or a B-picture may be 64×64.

Also, a largest coding unit may be hierarchically split into coding units based on split shape mode information obtained from a bitstream. At least one of information indicating whether quad splitting is performed, information indicating whether multi-splitting is performed, split direction information, and split type information may be obtained as the split shape mode information from the bitstream.

For example, the information indicating whether quad splitting is performed may indicate whether a current coding unit is quad split (QUAD_SPLIT) or not.

When the current coding unit is not quad split, the information indicating whether multi-splitting is performed may indicate whether the current coding unit is no longer split (NO_SPLIT) or binary/ternary split.

When the current coding unit is binary split or ternary split, the split direction information indicates that the current coding unit is split in one of a horizontal direction and a vertical direction.

When the current coding unit is split in the horizontal direction or the vertical direction, the split type information indicates that the current coding unit is binary split or ternary split.

A split mode of the current coding unit may be determined according to the split direction information and the split type information. A split mode when the current coding unit is binary split in the horizontal direction may be determined to be a binary horizontal split mode (SPLIT_BT_HOR), a split mode when the current coding unit is ternary split in the horizontal direction may be determined to be a ternary horizontal split mode (SPLIT_TT_HOR), a split mode when the current coding unit is binary split in the vertical direction may be determined to be a binary vertical split mode (SPLIT_BTVER), and a split mode when the current coding unit is ternary split in the vertical direction may be determined to be a ternary vertical split mode SPLIT_TT_VER.

The image decoding apparatus 100 may obtain, from the bitstream, the split shape mode information from one bin string. A form of the bitstream received by the image decoding apparatus 100 may include fixed length binary code, unary code, truncated unary code, pre-determined binary code, or the like. The bin string is information in a binary number. The bin string may include at least one bit. The image decoding apparatus 100 may obtain the split shape mode information corresponding to the bin string, based on the split rule. The image decoding apparatus 100 may determine whether to quad-split a coding unit, whether not to split a coding unit, a split direction, and a split type, based on one bin string.

The coding unit may be smaller than or same as the largest coding unit. For example, because a largest coding unit is a coding unit having a maximum size, the largest coding unit is one of coding units. When split shape mode information about a largest coding unit indicates that splitting is not performed, a coding unit determined in the largest coding unit has the same size as that of the largest coding unit. When split shape code information about a largest coding unit indicates that splitting is performed, the largest coding unit may be split into coding units. Also, when split shape mode information about a coding unit indicates that splitting is performed, the coding unit may be split into smaller coding units. However, the splitting of the image is not limited thereto, and the largest coding unit and the coding unit may not be distinguished. The splitting of the coding unit will be described in detail with reference to FIGS. 3 through 16.

Also, one or more prediction blocks for prediction may be determined from a coding unit. The prediction block may be the same as or smaller than the coding unit. Also, one or more transform blocks for transform may be determined from a coding unit. The transform block may be the same as or smaller than the coding unit.

The shapes and sizes of the transform block and prediction block may not be related to each other.

In another embodiment, prediction may be performed by using a coding unit as a prediction unit. Also, transform may be performed by using a coding unit as a transform block.

The splitting of the coding unit will be described in detail with reference to FIGS. 3 through 16. A current block and a neighboring block of the present disclosure may indicate one of the largest coding unit, the coding unit, the prediction block, and the transform block. Also, the current block of the current coding unit is a block that is currently being decoded or encoded or a block that is currently being split. The neighboring block may be a block reconstructed before the current block. The neighboring block may be adjacent to the current block spatially or temporally. The neighboring block may be located at one of the lower left, left, upper left, top, upper right, right, and lower right of the current block.

FIG. 3 illustrates a process, performed by an image decoding apparatus, of determining at least one coding unit by splitting a current coding unit, according to an embodiment.

A block shape may include 4N×4N, 4N×2N, 2N×4N, 4N×N, N×4N, 32N×N, N×32N, 16N×N, N×16N, 8N×N, or N×8N. Here, N may be a positive integer. Block shape information is information indicating at least one of a shape, a direction, a ratio of width and height, or a size of a coding unit.

The shape of the coding unit may include a square and a non-square. When the lengths of the width and height of the coding unit are the same (i.e., when the block shape of the coding unit is 4N×4N), the image decoding apparatus 100 may determine the block shape information of the coding unit to be a square. The image decoding apparatus 100 may determine the shape of the coding unit to be a non-square.

When the width and the height of the coding unit are different from each other (i.e., when the block shape of the coding unit is 4N×2N, 2N×4N, 4N×N, N×4N, 32N×N, N×32N, 16N×N, N×16N, 8N×N, or N×8N), the image decoding apparatus 100 may determine the block shape information of the coding unit to be a non-square shape. When the shape of the coding unit is non-square, the image decoding apparatus 100 may determine the ratio of the width and height among the block shape information of the coding unit to be at least one of 1:2, 2:1, 1:4, 4:1, 1:8, 8:1, 1:16, 16:1, 1:32, and 32:1. Also, the image decoding apparatus 100 may determine whether the coding unit is in a horizontal direction or a vertical direction, based on the length of the width and the length of the height of the coding unit. Also, the image decoding apparatus 100 may determine the size of the coding unit, based on at least one of the length of the width, the length of the height, or the area of the coding unit.

According to an embodiment, the image decoding apparatus 100 may determine the shape of the coding unit by using the block shape information, and may determine a splitting method of the coding unit by using the split shape mode information. That is, a coding unit splitting method indicated by the split shape mode information may be determined based on a block shape indicated by the block shape information used by the image decoding apparatus 100.

The image decoding apparatus 100 may obtain the split shape mode information from a bitstream. However, an embodiment is not limited thereto, and the image decoding apparatus 100 and the image encoding apparatus 2200 may determine pre-agreed split shape mode information, based on the block shape information. The image decoding apparatus 100 may determine the pre-agreed split shape mode information with respect to a largest coding unit or a smallest coding unit. For example, the image decoding apparatus 100 may determine split shape mode information with respect to the largest coding unit to be a quad split. Also, the image decoding apparatus 100 may determine split shape mode information regarding the smallest coding unit to be “not to perform splitting”. In particular, the image decoding apparatus 100 may determine the size of the largest coding unit to be 256×256. The image decoding apparatus 100 may determine the pre-agreed split shape mode information to be a quad split. The quad split is a split shape mode in which the width and the height of the coding unit are both bisected. The image decoding apparatus 100 may obtain a coding unit of a 128×128 size from the largest coding unit of a 256×256 size, based on the split shape mode information. Also, the image decoding apparatus 100 may determine the size of the smallest coding unit to be 4×4. The image decoding apparatus 100 may obtain split shape mode information indicating “not to perform splitting” with respect to the smallest coding unit.

According to an embodiment, the image decoding apparatus 100 may use the block shape information indicating that the current coding unit has a square shape. For example, the image decoding apparatus 100 may determine whether not to split a square coding unit, whether to vertically split the square coding unit, whether to horizontally split the square coding unit, or whether to split the square coding unit into four coding units, based on the split shape mode information. Referring to FIG. 3, when the block shape information of a current coding unit 300 indicates a square shape, the decoder 120 may not split a coding unit 310a having the same size as the current coding unit 300, based on the split shape mode information indicating not to perform splitting, or may determine coding units 310b, 310c, 310d, 310e, or 310f split based on the split shape mode information indicating a certain splitting method.

Referring to FIG. 3, according to an embodiment, the image decoding apparatus 100 may determine two coding units 310b obtained by splitting the current coding unit 300 in a vertical direction, based on the split shape mode information indicating to perform splitting in a vertical direction. The image decoding apparatus 100 may determine two coding units 310c obtained by splitting the current coding unit 300 in a horizontal direction, based on the split shape mode information indicating to perform splitting in a horizontal direction. The image decoding apparatus 100 may determine four coding units 310d obtained by splitting the current coding unit 300 in vertical and horizontal directions, based on the split shape mode information indicating to perform splitting in vertical and horizontal directions. According to an embodiment, the image decoding apparatus 100 may determine three coding units 310e obtained by splitting the current coding unit 300 in a vertical direction, based on the split shape mode information indicating to perform ternary-splitting in a vertical direction. The image decoding apparatus 100 may determine three coding units 310f obtained by splitting the current coding unit 300 in a horizontal direction, based on the split shape mode information indicating to perform ternary-splitting in a horizontal direction. However, splitting methods of the square coding unit are not limited to the above-described methods, and the split shape mode information may indicate various methods. Certain splitting methods of splitting the square coding unit will be described in detail below in relation to various embodiments.

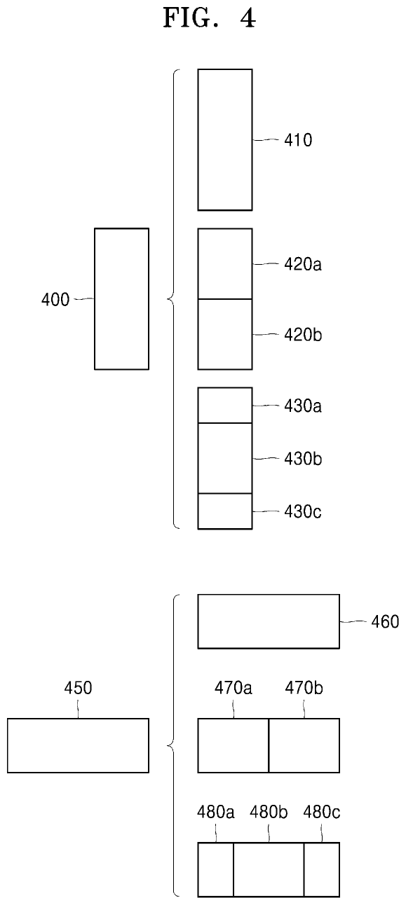

FIG. 4 illustrates a process, performed by an image decoding apparatus, of determining at least one coding unit by splitting a non-square coding unit, according to an embodiment.

According to an embodiment, the image decoding apparatus 100 may use block shape information indicating that a current coding unit has a non-square shape. The image decoding apparatus 100 may determine whether not to split the non-square current coding unit or whether to split the non-square current coding unit by using a certain splitting method, based on split shape mode information. Referring to FIG. 4, when the block shape information of a current coding unit 400 or 450 indicates a non-square shape, the image decoding apparatus 100 may determine a coding unit 410 or 460 having the same size as the current coding unit 400 or 450, based on the split shape mode information indicating not to perform splitting, or may determine coding units 420a and 420b, 430a to 430c, 470a and 470b, or 480a to 480c split based on the split shape mode information indicating a certain splitting method. Certain splitting methods of splitting a non-square coding unit will be described in detail below in relation to various embodiments.

According to an embodiment, the image decoding apparatus 100 may determine a splitting method of a coding unit by using the split shape mode information and, in this case, the split shape mode information may indicate the number of one or more coding units generated by splitting a coding unit. Referring to FIG. 4, when the split shape mode information indicates to split the current coding unit 400 or 450 into two coding units, the image decoding apparatus 100 may determine two coding units 420a and 420b, or 470a and 470b included in the current coding unit 400 or 450, by splitting the current coding unit 400 or 450 based on the split shape mode information.

According to an embodiment, when the image decoding apparatus 100 splits the non-square current coding unit 400 or 450 based on the split shape mode information, the image decoding apparatus 100 may consider the location of a long side of the non-square current coding unit 400 or 450 to split a current coding unit. For example, the image decoding apparatus 100 may determine a plurality of coding units by splitting a long side of the current coding unit 400 or 450, based on the shape of the current coding unit 400 or 450.

According to an embodiment, when the split shape mode information indicates to split (ternary-split) a coding unit into an odd number of blocks, the image decoding apparatus 100 may determine an odd number of coding units included in the current coding unit 400 or 450. For example, when the split shape mode information indicates to split the current coding unit 400 or 450 into three coding units, the image decoding apparatus 100 may split the current coding unit 400 or 450 into three coding units 430a, 430b, and 430c, or 480a, 480b, and 480c.

According to an embodiment, a ratio of the width and height of the current coding unit 400 or 450 may be 4:1 or 1:4. When the ratio of the width and height is 4:1, the block shape information may be a horizontal direction because the length of the width is longer than the length of the height. When the ratio of the width and height is 1:4, the block shape information may be a vertical direction because the length of the width is shorter than the length of the height. The image decoding apparatus 100 may determine to split a current coding unit into the odd number of blocks, based on the split shape mode information. Also, the image decoding apparatus 100 may determine a split direction of the current coding unit 400 or 450, based on the block shape information of the current coding unit 400 or 450. For example, when the current coding unit 400 is in the vertical direction, the image decoding apparatus 100 may determine the coding units 430a to 430c by splitting the current coding unit 400 in the horizontal direction. Also, when the current coding unit 450 is in the horizontal direction, the image decoding apparatus 100 may determine the coding units 480a to 480c by splitting the current coding unit 450 in the vertical direction.

According to an embodiment, the image decoding apparatus 100 may determine the odd number of coding units included in the current coding unit 400 or 450, and not all the determined coding units may have the same size. For example, a certain coding unit 430b or 480b from among the determined odd number of coding units 430a, 430b, and 430c, or 480a, 480b, and 480c may have a size different from the size of the other coding units 430a and 430c, or 480a and 480c. That is, coding units which may be determined by splitting the current coding unit 400 or 450 may have multiple sizes and, in some cases, all of the odd number of coding units 430a, 430b, and 430c, or 480a, 480b, and 480c may have different sizes.

According to an embodiment, when the split shape mode information indicates to split a coding unit into the odd number of blocks, the image decoding apparatus 100 may determine the odd number of coding units included in the current coding unit 400 or 450, and in addition, may put a certain restriction on at least one coding unit from among the odd number of coding units generated by splitting the current coding unit 400 or 450. Referring to FIG. 4, the image decoding apparatus 100 may set a decoding process regarding the coding unit 430b or 480b located at the center among the three coding units 430a, 430b, and 430c or 480a, 480b, and 480c generated as the current coding unit 400 or 450 is split to be different from that of the other coding units 430a and 430c, or 480a or 480c. For example, the image decoding apparatus 100 may restrict the coding unit 430b or 480b at the center location to be no longer split or to be split only a certain number of times, unlike the other coding units 430a and 430c, or 480a and 480c.

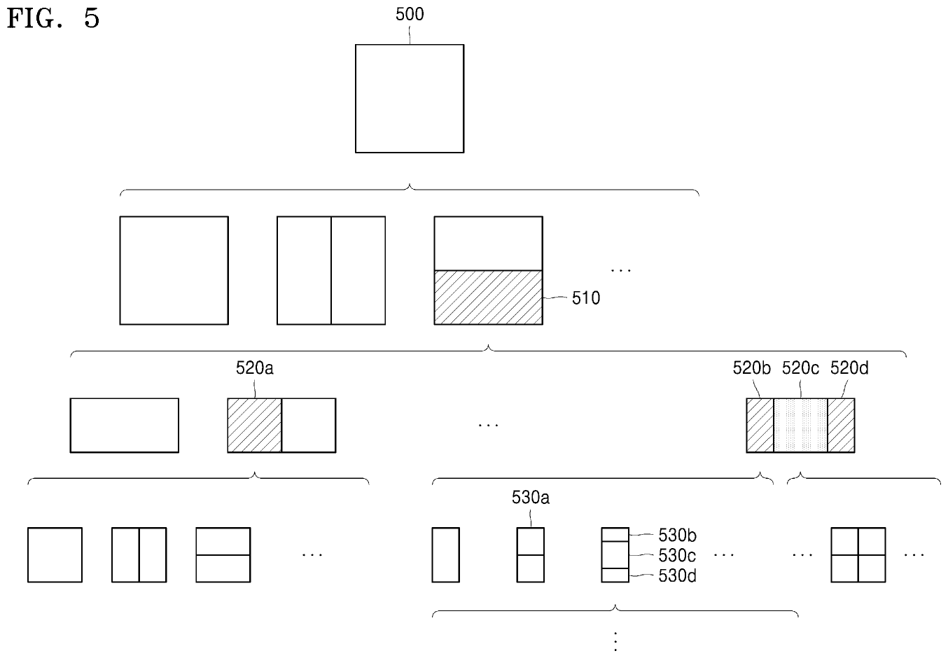

FIG. 5 illustrates a process, performed by an image decoding apparatus, of splitting a coding unit based on at least one of block shape information and split shape mode information, according to an embodiment.

According to an embodiment, the image decoding apparatus 100 may determine to split or not to split a square first coding unit 500 into coding units, based on at least one of the block shape information and the split shape mode information. According to an embodiment, when the split shape mode information indicates to split the first coding unit 500 in a horizontal direction, the image decoding apparatus 100 may determine a second coding unit 510 by splitting the first coding unit 500 in a horizontal direction. A first coding unit, a second coding unit, and a third coding unit used according to an embodiment are terms used to understand a relation before and after splitting a coding unit. For example, a second coding unit may be determined by splitting a first coding unit, and a third coding unit may be determined by splitting the second coding unit. It will be understood that the structure of the first coding unit, the second coding unit, and the third coding unit follows the above descriptions.

According to an embodiment, the image decoding apparatus 100 may determine to split or not to split the determined second coding unit 510 into coding units, based on the split shape mode information. Referring to FIG. 5, the image decoding apparatus 100 may or may not split the non-square second coding unit 510, which is determined by splitting the first coding unit 500, into one or more third coding units 520a, or 520b, 520c, and 520d based on the split shape mode information. The image decoding apparatus 100 may obtain the split shape mode information, and may obtain a plurality of various-shaped second coding units (e.g., 510) by splitting the first coding unit 500, based on the obtained split shape mode information, and the second coding unit 510 may be split by using a splitting method of the first coding unit 500 based on the split shape mode information. According to an embodiment, when the first coding unit 500 is split into the second coding units 510 based on the split shape mode information of the first coding unit 500, the second coding unit 510 may also be split into the third coding units 520a, or 520b, 520c, and 520d based on the split shape mode information of the second coding unit 510. That is, a coding unit may be recursively split based on the split shape mode information of each coding unit. Therefore, a square coding unit may be determined by splitting a non-square coding unit, and a non-square coding unit may be determined by recursively splitting the square coding unit.

Referring to FIG. 5, a certain coding unit from among the odd number of third coding units 520b, 520c, and 520d determined by splitting the non-square second coding unit 510 (e.g., a coding unit at a center location or a square coding unit) may be recursively split. According to an embodiment, the square third coding unit 520c from among the odd number of third coding units 520b, 520c, and 520d may be split in a horizontal direction into a plurality of fourth coding units. A non-square fourth coding unit 530b or 530d from among a plurality of fourth coding units 530a, 530b, 530c, and 530d may be split into a plurality of coding units again. For example, the non-square fourth coding unit 530b or 530d may be split into the odd number of coding units again. A method that may be used to recursively split a coding unit will be described below in relation to various embodiments.

According to an embodiment, the image decoding apparatus 100 may split each of the third coding units 520a, or 520b, 520c, and 520d into coding units, based on the split shape mode information. Also, the image decoding apparatus 100 may determine not to split the second coding unit 510 based on the split shape mode information. According to an embodiment, the image decoding apparatus 100 may split the non-square second coding unit 510 into the odd number of third coding units 520b, 520c, and 520d. The image decoding apparatus 100 may put a certain restriction on a certain third coding unit from among the odd number of third coding units 520b, 520c, and 520d. For example, the image decoding apparatus 100 may restrict the third coding unit 520c at a center location from among the odd number of third coding units 520b, 520c, and 520d to be no longer split or to be split a settable number of times.

Referring to FIG. 5, the image decoding apparatus 100 may restrict the third coding unit 520c, which is at the center location from among the odd number of third coding units 520b, 520c, and 520d included in the non-square second coding unit 510, to be no longer split, to be split by using a certain splitting method (e.g., split into only four coding units or split by using a splitting method of the second coding unit 510), or to be split only a certain number of times (e.g., split only n times (where n>0)). However, the restrictions on the third coding unit 520c at the center location are not limited to the above-described examples, and may include various restrictions for decoding the third coding unit 520c at the center location differently from the other third coding units 520b and 520d.

According to an embodiment, the image decoding apparatus 100 may obtain the split shape mode information, which is used to split a current coding unit, from a certain location in the current coding unit.

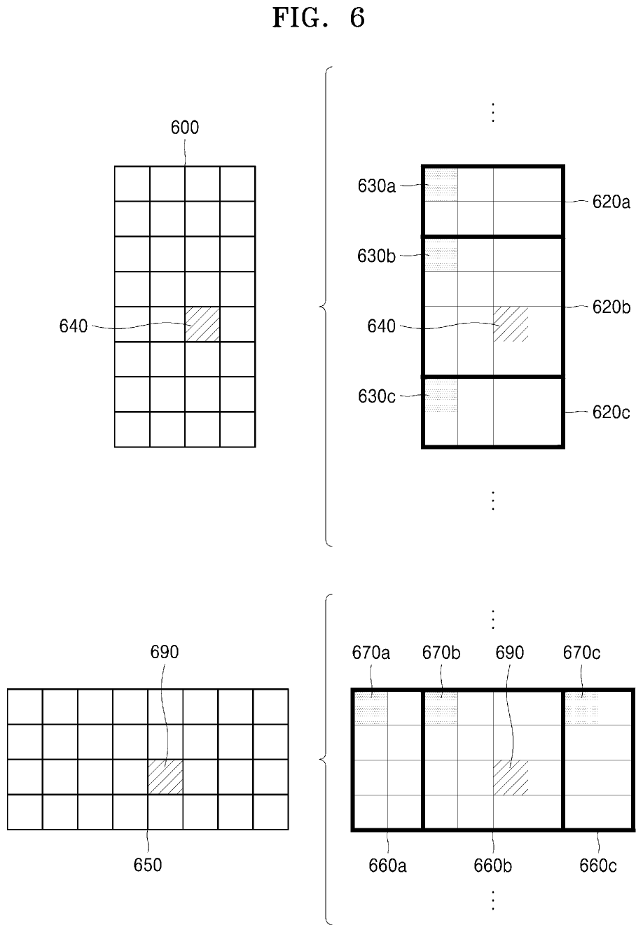

FIG. 6 illustrates a method, performed by an image decoding apparatus, of determining a certain coding unit from among an odd number of coding units, according to an embodiment.

Referring to FIG. 6, split shape mode information of a current coding unit 600 or 650 may be obtained from a sample of a certain location (e.g., a sample 640 or 690 of a center location) from among a plurality of samples included in the current coding unit 600 or 650. However, the certain location in the current coding unit 600, from which at least one piece of the split shape mode information may be obtained, is not limited to the center location in FIG. 6, and may include various locations included in the current coding unit 600 (e.g., top, bottom, left, right, upper left, lower left, upper right, and lower right locations). The image decoding apparatus 100 may obtain the split shape mode information from the certain location and may determine to split or not to split the current coding unit into various-shaped and various-sized coding units.

According to an embodiment, when the current coding unit is split into a certain number of coding units, the image decoding apparatus 100 may select one of the coding units. Various methods may be used to select one of a plurality of coding units, as will be described below in relation to various embodiments.

According to an embodiment, the image decoding apparatus 100 may split the current coding unit into a plurality of coding units, and may determine a coding unit at a certain location.

According to an embodiment, image decoding apparatus 100 may use information indicating locations of the odd number of coding units, to determine a coding unit at a center location from among the odd number of coding units. Referring to FIG. 6, the image decoding apparatus 100 may determine the odd number of coding units 620a, 620b, and 620c or the odd number of coding units 660a, 660b, and 660c by splitting the current coding unit 600 or the current coding unit 650. The image decoding apparatus 100 may determine the middle coding unit 620b or the middle coding unit 660b by using information about the locations of the odd number of coding units 620a, 620b, and 620c or the odd number of coding units 660a, 660b, and 660c. For example, the image decoding apparatus 100 may determine the coding unit 620b of the center location by determining the locations of the coding units 620a, 620b, and 620c based on information indicating locations of certain samples included in the coding units 620a, 620b, and 620c. In detail, the image decoding apparatus 100 may determine the coding unit 620b at the center location by determining the locations of the coding units 620a, 620b, and 620c based on information indicating locations of upper left samples 630a, 630b, and 630c of the coding units 620a, 620b, and 620c.

According to an embodiment, the information indicating the locations of the upper left samples 630a, 630b, and 630c, which are included in the coding units 620a, 620b, and 620c, respectively, may include information about locations or coordinates of the coding units 620a, 620b, and 620c in a picture. According to an embodiment, the information indicating the locations of the upper left samples 630a, 630b, and 630c, which are included in the coding units 620a, 620b, and 620c, respectively, may include information indicating widths or heights of the coding units 620a, 620b, and 620c included in the current coding unit 600, and the widths or heights may correspond to information indicating differences between the coordinates of the coding units 620a, 620b, and 620c in the picture. That is, the image decoding apparatus 100 may determine the coding unit 620b at the center location by directly using the information about the locations or coordinates of the coding units 620a, 620b, and 620c in the picture, or by using the information about the widths or heights of the coding units, which correspond to the difference values between the coordinates.

According to an embodiment, information indicating the location of the upper left sample 630a of the upper coding unit 620a may include coordinates (xa, ya), information indicating the location of the upper left sample 630b of the middle coding unit 620b may include coordinates (xb, yb), and information indicating the location of the upper left sample 630c of the lower coding unit 620c may include coordinates (xc, yc). The image decoding apparatus 100 may determine the middle coding unit 620b by using the coordinates of the upper left samples 630a, 630b, and 630c which are included in the coding units 620a, 620b, and 620c, respectively. For example, when the coordinates of the upper left samples 630a, 630b, and 630c are sorted in an ascending or descending order, the coding unit 620b including the coordinates (xb, yb) of the sample 630b at a center location may be determined as a coding unit at a center location from among the coding units 620a, 620b, and 620c determined by splitting the current coding unit 600. However, the coordinates indicating the locations of the upper left samples 630a, 630b, and 630c may include coordinates indicating absolute locations in the picture, or may use coordinates (dxb, dyb) indicating a relative location of the upper left sample 630b of the middle coding unit 620b and coordinates (dxc, dyc) indicating a relative location of the upper left sample 630c of the lower coding unit 620c with reference to the location of the upper left sample 630a of the upper coding unit 620a. A method of determining a coding unit at a certain location by using coordinates of a sample included in the coding unit, as information indicating a location of the sample, is not limited to the above-described method, and may include various arithmetic methods capable of using the coordinates of the sample.

According to an embodiment, the image decoding apparatus 100 may split the current coding unit 600 into a plurality of coding units 620a, 620b, and 620c, and may select one of the coding units 620a, 620b, and 620c based on a certain criterion. For example, the image decoding apparatus 100 may select the coding unit 620b, which has a size different from that of the others, from among the coding units 620a, 620b, and 620c.

According to an embodiment, the image decoding apparatus 100 may determine the width or height of each of the coding units 620a, 620b, and 620c by using the coordinates (xa, ya) that is the information indicating the location of the upper left sample 630a of the upper coding unit 620a, the coordinates (xb, yb) that is the information indicating the location of the upper left sample 630b of the middle coding unit 620b, and the coordinates (xc, yc) that is the information indicating the location of the upper left sample 630c of the lower coding unit 620c. The image decoding apparatus 100 may determine the respective sizes of the coding units 620a, 620b, and 620c by using the coordinates (xa, ya), (xb, yb), and (xc, yc) indicating the locations of the coding units 620a, 620b, and 620c. According to an embodiment, the image decoding apparatus 100 may determine the width of the upper coding unit 620a to be the width of the current coding unit 600. The image decoding apparatus 100 may determine the height of the upper coding unit 620a to be yb-ya. According to an embodiment, the image decoding apparatus 100 may determine the width of the middle coding unit 620b to be the width of the current coding unit 600. The image decoding apparatus 100 may determine the height of the middle coding unit 620b to be yc-yb. According to an embodiment, the image decoding apparatus 100 may determine the width or height of the lower coding unit 620c by using the width or height of the current coding unit 600 or the widths or heights of the upper and middle coding units 620a and 620b. The image decoding apparatus 100 may determine a coding unit, which has a size different from that of the others, based on the determined widths and heights of the coding units 620a to 620c. Referring to FIG. 6, the image decoding apparatus 100 may determine the middle coding unit 620b, which has a size different from the size of the upper and lower coding units 620a and 620c, as the coding unit of the certain location. However, the above-described method, performed by the image decoding apparatus 100, of determining a coding unit having a size different from the size of the other coding units merely corresponds to an example of determining a coding unit at a certain location by using the sizes of coding units, which are determined based on coordinates of samples, and thus, various methods of determining a coding unit at a certain location by comparing the sizes of coding units, which are determined based on coordinates of certain samples, may be used.

The image decoding apparatus 100 may determine the width or height of each of the coding units 660a, 660b, and 660c by using the coordinates (xd, yd) that is information indicating the location of an upper left sample 670a of the left coding unit 660a, the coordinates (xe, ye) that is information indicating the location of an upper left sample 670b of the middle coding unit 660b, and the coordinates (xf, yf) that is information indicating a location of the upper left sample 670c of the right coding unit 660c. The image decoding apparatus 100 may determine the respective sizes of the coding units 660a, 660b, and 660c by using the coordinates (xd, yd), (xe, ye), and (xf, yf) indicating the locations of the coding units 660a, 660b, and 660c.

According to an embodiment, the image decoding apparatus 100 may determine the width of the left coding unit 660a to be xe-xd. The image decoding apparatus 100 may determine the height of the left coding unit 660a to be the height of the current coding unit 650. According to an embodiment, the image decoding apparatus 100 may determine the width of the middle coding unit 660b to be xf-xe. The image decoding apparatus 100 may determine the height of the middle coding unit 660b to be the height of the current coding unit 650. According to an embodiment, the image decoding apparatus 100 may determine the width or height of the right coding unit 660c by using the width or height of the current coding unit 650 or the widths or heights of the left and middle coding units 660a and 660b. The image decoding apparatus 100 may determine a coding unit, which has a size different from that of the others, based on the determined widths and heights of the coding units 660a to 660c. Referring to FIG. 6, the image decoding apparatus 100 may determine the middle coding unit 660b, which has a size different from the sizes of the left and right coding units 660a and 660c, as the coding unit of the certain location. However, the above-described method, performed by the image decoding apparatus 100, of determining a coding unit having a size different from the size of the other coding units merely corresponds to an example of determining a coding unit at a certain location by using the sizes of coding units, which are determined based on coordinates of samples, and thus, various methods of determining a coding unit at a certain location by comparing the sizes of coding units, which are determined based on coordinates of certain samples, may be used.

However, locations of samples considered to determine locations of coding units are not limited to the above-described upper left locations, and information about arbitrary locations of samples included in the coding units may be used.

According to an embodiment, the image decoding apparatus 100 may select a coding unit at a certain location from among an odd number of coding units determined by splitting the current coding unit, considering the shape of the current coding unit. For example, when the current coding unit has a non-square shape, a width of which is longer than a height, the image decoding apparatus 100 may determine the coding unit at the certain location in a horizontal direction. That is, the image decoding apparatus 100 may determine one of coding units at different locations in a horizontal direction and put a restriction on the coding unit. When the current coding unit has a non-square shape, a height of which is longer than a width, the image decoding apparatus 100 may determine the coding unit at the certain location in a vertical direction. That is, the image decoding apparatus 100 may determine one of coding units at different locations in a vertical direction and may put a restriction on the coding unit.

According to an embodiment, the image decoding apparatus 100 may use information indicating respective locations of an even number of coding units, to determine the coding unit at the certain location from among the even number of coding units. The image decoding apparatus 100 may determine an even number of coding units by splitting (binary-splitting) the current coding unit, and may determine the coding unit at the certain location by using the information about the locations of the even number of coding units. An operation related thereto may correspond to the operation of determining a coding unit at a certain location (e.g., a center location) from among an odd number of coding units, which has been described in detail above in relation to FIG. 6, and thus, detailed descriptions thereof are not provided here.

According to an embodiment, when a non-square current coding unit is split into a plurality of coding units, certain information about a coding unit at a certain location may be used in a splitting operation to determine the coding unit at the certain location from among the plurality of coding units. For example, the image decoding apparatus 100 may use at least one of block shape information and split shape mode information, which is stored in a sample included in a middle coding unit, in a splitting operation to determine a coding unit at a center location from among the plurality of coding units determined by splitting the current coding unit.

Referring to FIG. 6, the image decoding apparatus 100 may split the current coding unit 600 into the plurality of coding units 620a, 620b, and 620c based on the split shape mode information, and may determine the coding unit 620b at a center location from among the plurality of the coding units 620a, 620b, and 620c. Furthermore, the image decoding apparatus 100 may determine the coding unit 620b at the center location, based on a location from which the split shape mode information is obtained. That is, the split shape mode information of the current coding unit 600 may be obtained from the sample 640 at a center location of the current coding unit 600 and, when the current coding unit 600 is split into the plurality of coding units 620a, 620b, and 620c based on the split shape mode information, the coding unit 620b including the sample 640 may be determined as the coding unit at the center location. However, information used to determine the coding unit at the center location is not limited to the split shape mode information, and various types of information may be used to determine the coding unit at the center location.

According to an embodiment, certain information for identifying the coding unit at the certain location may be obtained from a certain sample included in a coding unit to be determined. Referring to FIG. 6, the image decoding apparatus 100 may use the split shape mode information, which is obtained from a sample at a certain location in the current coding unit 600 (e.g., a sample at a center location of the current coding unit 600) to determine a coding unit at a certain location from among the plurality of the coding units 620a, 620b, and 620c determined by splitting the current coding unit 600 (e.g., a coding unit at a center location from among a plurality of split coding units). That is, the image decoding apparatus 100 may determine the sample at the certain location by considering a block shape of the current coding unit 600, determine the coding unit 620b including a sample, from which certain information (e.g., the split shape mode information) may be obtained, from among the plurality of coding units 620a, 620b, and 620c determined by splitting the current coding unit 600, and may put a certain restriction on the coding unit 620b. Referring to FIG. 6, according to an embodiment, the image decoding apparatus 100 may determine the sample 640 at the center location of the current coding unit 600 as the sample from which the certain information may be obtained, and may put a certain restriction on the coding unit 620b including the sample 640, in a decoding operation. However, the location of the sample from which the certain information may be obtained is not limited to the above-described location, and may include arbitrary locations of samples included in the coding unit 620b to be determined for a restriction.

According to an embodiment, the location of the sample from which the certain information may be obtained may be determined based on the shape of the current coding unit 600. According to an embodiment, the block shape information may indicate whether the current coding unit has a square or non-square shape, and the location of the sample from which the certain information may be obtained may be determined based on the shape. For example, the image decoding apparatus 100 may determine a sample located on a boundary for splitting at least one of a width and height of the current coding unit in half, as the sample from which the certain information may be obtained, by using at least one of information about the width of the current coding unit and information about the height of the current coding unit. As another example, when the block shape information of the current coding unit indicates a non-square shape, the image decoding apparatus 100 may determine one of samples including a boundary for splitting a long side of the current coding unit in half, as the sample from which the predetermined information may be obtained.

According to an embodiment, when the current coding unit is split into a plurality of coding units, the image decoding apparatus 100 may use the split shape mode information to determine a coding unit at a certain location from among the plurality of coding units. According to an embodiment, the image decoding apparatus 100 may obtain the split shape mode information from a sample at a certain location in a coding unit, and split the plurality of coding units, which are generated by splitting the current coding unit, by using the split shape mode information, which is obtained from the sample of the certain location in each of the plurality of coding units. That is, a coding unit may be recursively split based on the split shape mode information, which is obtained from the sample at the certain location in each coding unit. An operation of recursively splitting a coding unit has been described above in relation to FIG. 5, and thus, detailed descriptions thereof will not be provided here.

According to an embodiment, the image decoding apparatus 100 may determine one or more coding units by splitting the current coding unit, and may determine an order of decoding the one or more coding units, based on a certain block (e.g., the current coding unit).

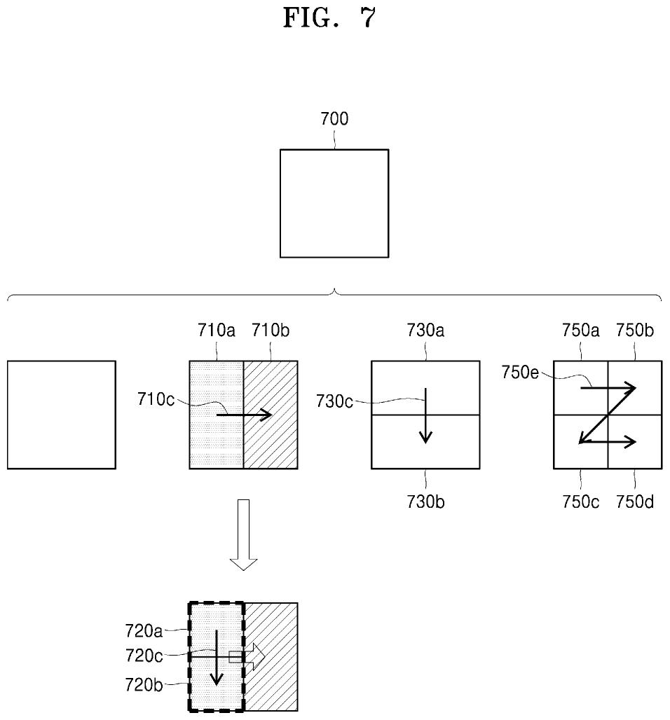

FIG. 7 illustrates an order of processing a plurality of coding units when an image decoding apparatus determines the plurality of coding units by splitting a current coding unit, according to an embodiment.

According to an embodiment, the image decoding apparatus 100 may determine second coding units 710a and 710b by splitting a first coding unit 700 in a vertical direction, determine second coding units 730a and 730b by splitting the first coding unit 700 in a horizontal direction, or determine second coding units 750a to 750d by splitting the first coding unit 700 in vertical and horizontal directions, based on split shape mode information.

Referring to FIG. 7, the image decoding apparatus 100 may determine to process the second coding units 710a and 710b, which are determined by splitting the first coding unit 700 in a vertical direction, in a horizontal direction order 710c. The image decoding apparatus 100 may determine to process the second coding units 730a and 730b, which are determined by splitting the first coding unit 700 in a horizontal direction, in a vertical direction order 730c. The image decoding apparatus 100 may determine to process the second coding units 750a to 750d, which are determined by splitting the first coding unit 700 in vertical and horizontal directions, in a certain order for processing coding units in a row and then processing coding units in a next row (e.g., in a raster scan order or Z-scan order 750e).

According to an embodiment, the image decoding apparatus 100 may recursively split coding units. Referring to FIG. 7, the image decoding apparatus 100 may determine the plurality of coding units 710a and 710b, 730a and 730b, or 750a to 750d by splitting the first coding unit 700, and recursively split each of the determined plurality of coding units 710a and 710b, 730a and 730b, or 750a to 750d. A splitting method of the plurality of coding units 710a and 710b, 730a and 730b, or 750a to 750d may correspond to a splitting method of the first coding unit 700. As such, each of the plurality of coding units 710a and 710b, 730a and 730b, or 750a to 750d may be independently split into a plurality of coding units. Referring to FIG. 7, the image decoding apparatus 100 may determine the second coding units 710a and 710b by splitting the first coding unit 700 in a vertical direction, and may determine to independently split or not to split each of the second coding units 710a and 710b.

According to an embodiment, the image decoding apparatus 100 may determine third coding units 720a and 720b by splitting the left second coding unit 710a in a horizontal direction, and may not split the right second coding unit 710b.

According to an embodiment, a processing order of coding units may be determined based on an operation of splitting a coding unit. In other words, a processing order of split coding units may be determined based on a processing order of coding units immediately before being split. The image decoding apparatus 100 may determine a processing order of the third coding units 720a and 720b determined by splitting the left second coding unit 710a, independently of the right second coding unit 710b. Because the third coding units 720a and 720b are determined by splitting the left second coding unit 710a in a horizontal direction, the third coding units 720a and 720b may be processed in a vertical direction order 720c. Because the left and right second coding units 710a and 710b are processed in the horizontal direction order 710c, the right second coding unit 710b may be processed after the third coding units 720a and 720b included in the left second coding unit 710a are processed in the vertical direction order 720c. An operation of determining a processing order of coding units based on a coding unit before being split is not limited to the above-described example, and various methods may be used to independently process coding units, which are split and determined to have various shapes, in a certain order.

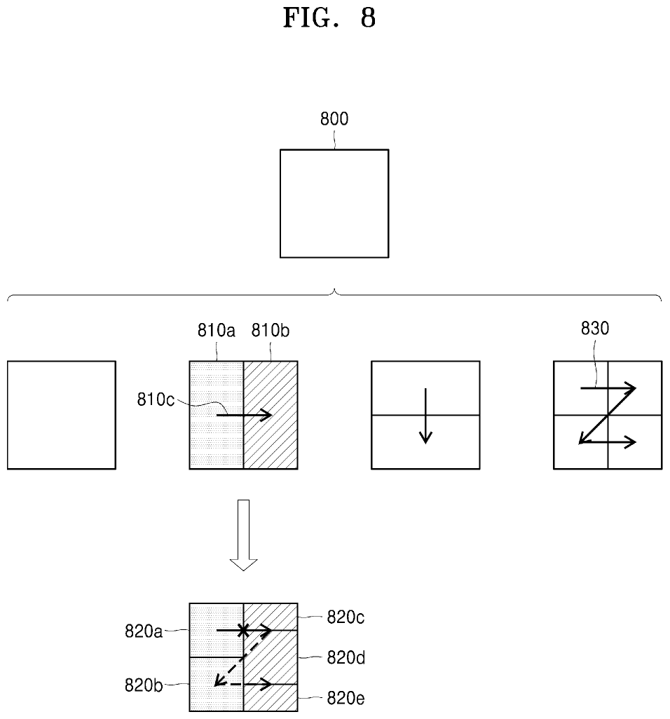

FIG. 8 illustrates a process, performed by an image decoding apparatus, of determining that a current coding unit is to be split into an odd number of coding units, when the coding units are not processable in a certain order, according to an embodiment.

According to an embodiment, the image decoding apparatus 100 may determine that the current coding unit is split into an odd number of coding units, based on obtained split shape mode information. Referring to FIG. 8, a square first coding unit 800 may be split into non-square second coding units 810a and 810b, and the second coding units 810a and 810b may be independently split into third coding units 820a and 820b, and 820c to 820e. According to an embodiment, the image decoding apparatus 100 may determine the plurality of third coding units 820a and 820b by splitting the left second coding unit 810a in a horizontal direction, and may split the right second coding unit 810b into the odd number of third coding units 820c to 820e.

According to an embodiment, the image decoding apparatus 100 may determine whether any coding unit is split into an odd number of coding units, by determining whether the third coding units 820a and 820b, and 820c to 820e are processable in a certain order. Referring to FIG. 8, the image decoding apparatus 100 may determine the third coding units 820a and 820b, and 820c to 820e by recursively splitting the first coding unit 800. The image decoding apparatus 100 may determine whether any of the first coding unit 800, the second coding units 810a and 810b, and the third coding units 820a and 820b, and 820c to 820e are split into an odd number of coding units, based on at least one of the block shape information and the split shape mode information. For example, the right second coding unit 810b among the second coding units 810a and 810b may be split into an odd number of third coding units 820c, 820d, and 820e. A processing order of a plurality of coding units included in the first coding unit 800 may be a certain order (e.g., a Z-scan order 830), and the image decoding apparatus 100 may determine whether the third coding units 820c, 820d, and 820e, which are determined by splitting the right second coding unit 810b into an odd number of coding units, satisfy a condition for processing in the certain order.

According to an embodiment, the image decoding apparatus 100 may determine whether the third coding units 820a and 820b, and 820c to 820e included in the first coding unit 800 satisfy the condition for processing in the certain order, and the condition relates to whether at least one of a width and height of the second coding units 810a and 810b is split in half along a boundary of the third coding units 820a and 820b, and 820c to 820e. For example, the third coding units 820a and 820b determined when the height of the left second coding unit 810a of the non-square shape is split in half may satisfy the condition. It may be determined that the third coding units 820c to 820e do not satisfy the condition because the boundaries of the third coding units 820c to 820e determined when the right second coding unit 810b is split into three coding units are unable to split the width or height of the right second coding unit 810b in half. When the condition is not satisfied as described above, the image decoding apparatus 100 may determine disconnection of a scan order, and may determine that the right second coding unit 810b is split into an odd number of coding units, based on a result of the determination. According to an embodiment, when a coding unit is split into an odd number of coding units, the image decoding apparatus 100 may put a certain restriction on a coding unit at a certain location from among the split coding units. The restriction or the certain location has been described above in relation to various embodiments, and thus, detailed descriptions thereof will not be provided herein.

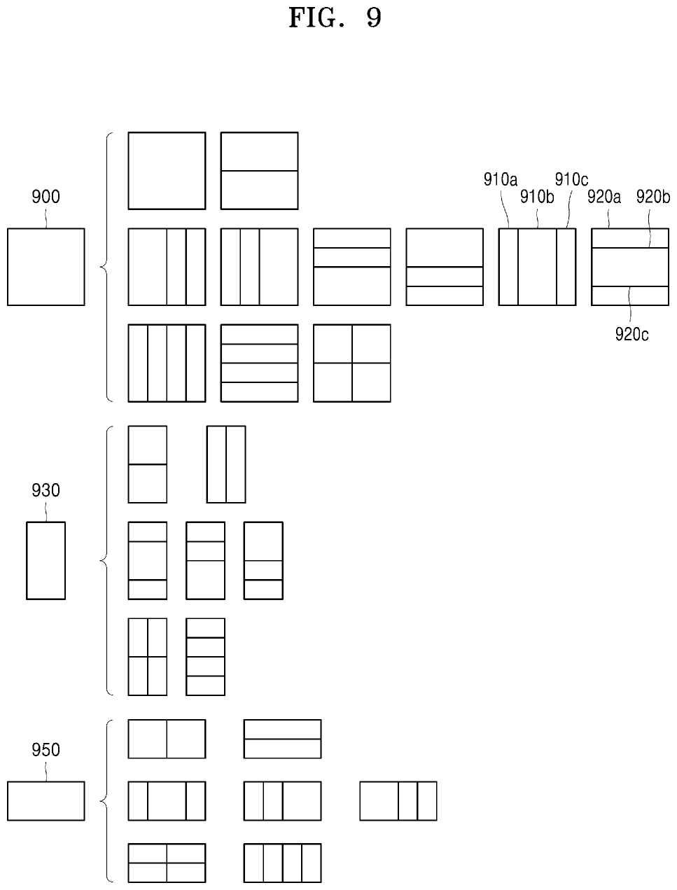

FIG. 9 illustrates a process, performed by an image decoding apparatus, of determining at least one coding unit by splitting a first coding unit, according to an embodiment.

According to an embodiment, the image decoding apparatus 100 may split the first coding unit 900, based on split shape mode information, which is obtained through the receiver 110. The square first coding unit 900 may be split into four square coding units, or may be split into a plurality of non-square coding units. For example, referring to FIG. 9, when the split shape mode information indicates to split the first coding unit 900 into non-square coding units, the image decoding apparatus 100 may split the first coding unit 900 into a plurality of non-square coding units. In detail, when the split shape mode information indicates to determine an odd number of coding units by splitting the first coding unit 900 in a horizontal direction or a vertical direction, the image decoding apparatus 100 may split the square first coding unit 900 into an odd number of coding units, e.g., second coding units 910a, 910b, and 910c determined by splitting the square first coding unit 900 in a vertical direction or second coding units 920a, 920b, and 920c determined by splitting the square first coding unit 900 in a horizontal direction.

According to an embodiment, the image decoding apparatus 100 may determine whether the second coding units 910a, 910b, 910c, 920a, 920b, and 920c included in the first coding unit 900 satisfy a condition for processing in a certain order, and the condition relates to whether at least one of a width and height of the first coding unit 900 is split in half along a boundary of the second coding units 910a, 910b, 910c, 920a, 920b, and 920c. Referring to FIG. 9, because boundaries of the second coding units 910a, 910b, and 910c determined by splitting the square first coding unit 900 in a vertical direction do not split the width of the first coding unit 900 in half, it may be determined that the first coding unit 900 does not satisfy the condition for processing in the certain order. In addition, because boundaries of the second coding units 920a, 920b, and 920c determined by splitting the square first coding unit 900 in a horizontal direction do not split the width of the first coding unit 900 in half, it may be determined that the first coding unit 900 does not satisfy the condition for processing in the certain order. When the condition is not satisfied as described above, the image decoding apparatus 100 may decide disconnection of a scan order, and may determine that the first coding unit 900 is split into an odd number of coding units, based on a result of the decision. According to an embodiment, when a coding unit is split into an odd number of coding units, the image decoding apparatus 100 may put a certain restriction on a coding unit at a certain location from among the split coding units. The restriction or the certain location has been described above in relation to various embodiments, and thus, detailed descriptions thereof will not be provided herein.

According to an embodiment, the image decoding apparatus 100 may determine various-shaped coding units by splitting a first coding unit.

Referring to FIG. 9, the image decoding apparatus 100 may split the square first coding unit 900 or a non-square first coding unit 930 or 950 into various-shaped coding units.

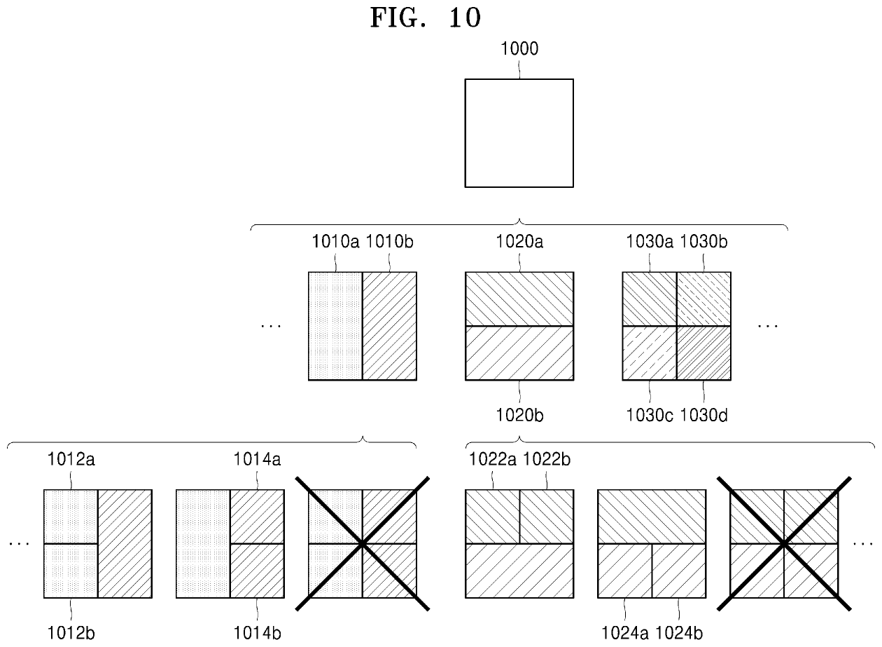

FIG. 10 illustrates that a shape into which a second coding unit is splittable is restricted when the second coding unit having a non-square shape, which is determined when an image decoding apparatus splits a first coding unit, satisfies a certain condition, according to an embodiment.

According to an embodiment, the image decoding apparatus 100 may determine to split the square first coding unit 1000 into non-square second coding units 1010a and 1010b or 1020a and 1020b, based on split shape mode information, which is obtained by the receiver 110. The second coding units 1010a and 1010b or 1020a and 1020b may be independently split. As such, the image decoding apparatus 100 may determine to split or not to split each of the second coding units 1010a and 1010b or 1020a and 1020b into a plurality of coding units, based on the split shape mode information of each of the second coding units 1010a and 1010b or 1020a and 1020b. According to an embodiment, the image decoding apparatus 100 may determine third coding units 1012a and 1012b by splitting the non-square left second coding unit 1010a, which is determined by splitting the first coding unit 1000 in a vertical direction, in a horizontal direction. However, when the left second coding unit 1010a is split in a horizontal direction, the image decoding apparatus 100 may restrict the right second coding unit 1010b to not be split in a horizontal direction in which the left second coding unit 1010a is split. When third coding units 1014a and 1014b are determined by splitting the right second coding unit 1010b in a same direction, because the left and right second coding units 1010a and 1010b are independently split in a horizontal direction, the third coding units 1012a and 1012b or 1014a and 1014b may be determined. However, this case serves equally as a case in which the image decoding apparatus 100 splits the first coding unit 1000 into four square second coding units 1030a, 1030b, 1030c, and 1030d, based on the split shape mode information, and may be inefficient in terms of image decoding.

According to an embodiment, the image decoding apparatus 100 may determine third coding units 1022a and 1022b or 1024a and 1024b by splitting the non-square second coding unit 1020a or 1020b, which is determined by splitting the first coding unit 1000 in a horizontal direction, in a vertical direction. However, when a second coding unit (e.g., the upper second coding unit 1020a) is split in a vertical direction, for the above-described reason, the image decoding apparatus 100 may restrict the other second coding unit (e.g., the lower second coding unit 1020b) to not be split in a vertical direction in which the upper second coding unit 1020a is split.

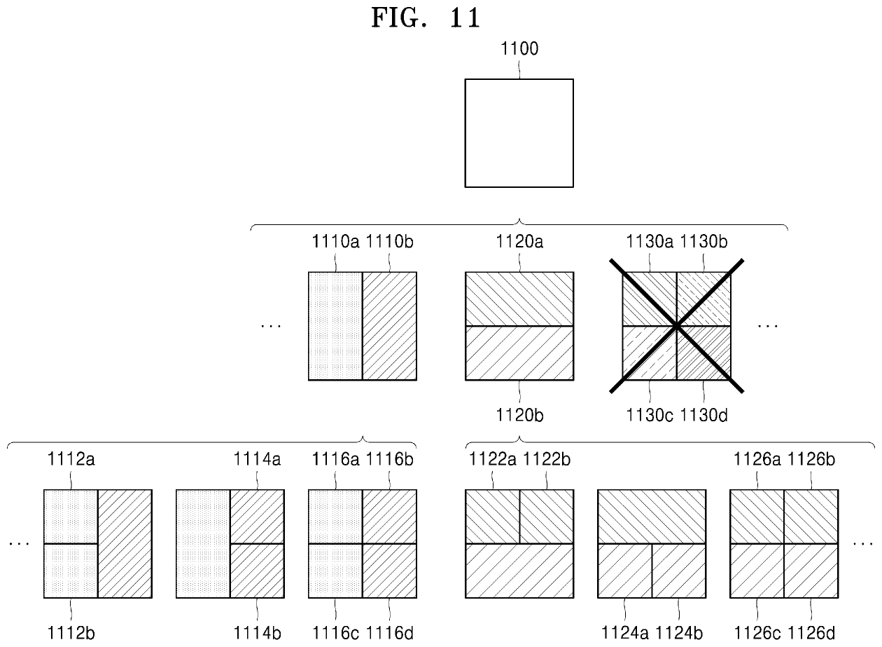

FIG. 11 illustrates a process, performed by an image decoding apparatus, of splitting a square coding unit when split shape mode information is unable to indicate that the square coding unit is split into four square coding units, according to an embodiment.

According to an embodiment, the image decoding apparatus 100 may determine second coding units 1110a and 1110b or 1120a and 1120b, etc. by splitting a first coding unit 1100, based on split shape mode information. The split shape mode information may include information about various methods of splitting a coding unit but, the information about various splitting methods may not include information for splitting a coding unit into four square coding units. According to such split shape mode information, the image decoding apparatus 100 may not split the square first coding unit 1100 into four square second coding units 1130a, 1130b, 1130c, and 1130d. The image decoding apparatus 100 may determine the non-square second coding units 1110a and 1110b or 1120a and 1120b, etc., based on the split shape mode information.

According to an embodiment, the image decoding apparatus 100 may independently split the non-square second coding units 1110a and 1110b or 1120a and 1120b, etc. Each of the second coding units 1110a and 1110b or 1120a and 1120b, etc. may be recursively split in a certain order, and this splitting method may correspond to a method of splitting the first coding unit 1100, based on the split shape mode information.

For example, the image decoding apparatus 100 may determine square third coding units 1112a and 1112b by splitting the left second coding unit 1110a in a horizontal direction, and may determine square third coding units 1114a and 1114b by splitting the right second coding unit 1110b in a horizontal direction. Furthermore, the image decoding apparatus 100 may determine square third coding units 1116a, 1116b, 1116c, and 1116d by splitting both of the left and right second coding units 1110a and 1110b in a horizontal direction. In this case, coding units having the same shape as the four square second coding units 1130a, 1130b, 1130c, and 1130d split from the first coding unit 1100 may be determined.

As another example, the image decoding apparatus 100 may determine square third coding units 1122a and 1122b by splitting the upper second coding unit 1120a in a vertical direction, and may determine square third coding units 1124a and 1124b by splitting the lower second coding unit 1120b in a vertical direction. Furthermore, the image decoding apparatus 100 may determine square third coding units 1126a, 1126b, 1126c, and 1126d by splitting both of the upper and lower second coding units 1120a and 1120b in a vertical direction. In this case, coding units having the same shape as the four square second coding units 1130a, 1130b, 1130c, and 1130d split from the first coding unit 1100 may be determined.

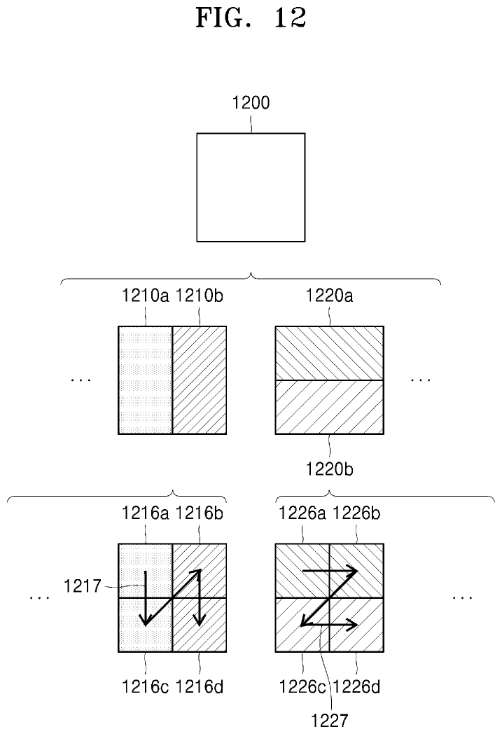

FIG. 12 illustrates that a processing order between a plurality of coding units may be changed depending on a process of splitting a coding unit, according to an embodiment.

According to an embodiment, the image decoding apparatus 100 may split a first coding unit 1200, based on split shape mode information. When a block shape indicates a square shape and the split shape mode information indicates to split the first coding unit 1200 in at least one of horizontal and vertical directions, the image decoding apparatus 100 may determine second coding units 1210a and 1210b or 1220a and 1220b, etc. by splitting the first coding unit 1200. Referring to FIG. 12, the non-square second coding units 1210a and 1210b or 1220a and 1220b determined by splitting the first coding unit 1200 in only a horizontal direction or vertical direction may be independently split based on the split shape mode information of each coding unit. For example, the image decoding apparatus 100 may determine third coding units 1216a, 1216b, 1216c, and 1216d by splitting the second coding units 1210a and 1210b, which are generated by splitting the first coding unit 1200 in a vertical direction, in a horizontal direction, and may determine third coding units 1226a, 1226b, 1226c, and 1226d by splitting the second coding units 1220a and 1220b, which are generated by splitting the first coding unit 1200 in a horizontal direction, in a vertical direction. An operation of splitting the second coding units 1210a and 1210b or 1220a and 1220b has been described above in relation to FIG. 11, and thus, detailed descriptions thereof will not be provided herein.

According to an embodiment, the image decoding apparatus 100 may process coding units in a certain order. An operation of processing coding units in a certain order has been described above in relation to FIG. 7, and thus, detailed descriptions thereof will not be provided herein. Referring to FIG. 12, the image decoding apparatus 100 may determine four square third coding units 1216a, 1216b, 1216c, and 1216d, and 1226a, 1226b, 1226c, and 1226d by splitting the square first coding unit 1200. According to an embodiment, the image decoding apparatus 100 may determine processing orders of the third coding units 1216a, 1216b, 1216c, and 1216d, and 1226a, 1226b, 1226c, and 1226d based on a splitting method of the first coding unit 1200.

According to an embodiment, the image decoding apparatus 100 may determine the third coding units 1216a, 1216b, 1216c, and 1216d by splitting the second coding units 1210a and 1210b generated by splitting the first coding unit 1200 in a vertical direction, in a horizontal direction, and may process the third coding units 1216a, 1216b, 1216c, and 1216d in a processing order 1217 for initially processing the third coding units 1216a and 1216c, which are included in the left second coding unit 1210a, in a vertical direction and then processing the third coding unit 1216b and 1216d, which are included in the right second coding unit 1210b, in a vertical direction.

According to an embodiment, the image decoding apparatus 100 may determine the third coding units 1226a, 1226b, 1226c, and 1226d by splitting the second coding units 1220a and 1220b generated by splitting the first coding unit 1200 in a horizontal direction, in a vertical direction, and may process the third coding units 1226a, 1226b, 1226c, and 1226d in a processing order 1227 for initially processing the third coding units 1226a and 1226b, which are included in the upper second coding unit 1220a, in a horizontal direction and then processing the third coding unit 1226c and 1226d, which are included in the lower second coding unit 1220b, in a horizontal direction.

Referring to FIG. 12, the square third coding units 1216a, 1216b, 1216c, and 1216d, and 1226a, 1226b, 1226c, and 1226d may be determined by splitting the second coding units 1210a and 1210b, and 1220a and 1920b, respectively. Although the second coding units 1210a and 1210b are determined by splitting the first coding unit 1200 in a vertical direction differently from the second coding units 1220a and 1220b which are determined by splitting the first coding unit 1200 in a horizontal direction, the third coding units 1216a, 1216b, 1216c, and 1216d, and 1226a, 1226b, 1226c, and 1226d split therefrom eventually show same-shaped coding units split from the first coding unit 1200. As such, by recursively splitting a coding unit in different manners based on the split shape information, the image decoding apparatus 100 may process a plurality of coding units in different orders even when the coding units are eventually determined to be the same shape.

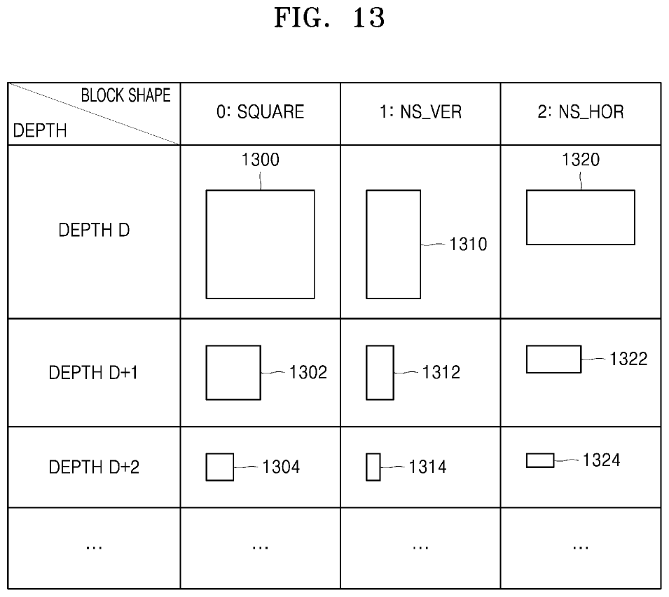

FIG. 13 illustrates a process of determining a depth of a coding unit when a shape and size of the coding unit change, when the coding unit is recursively split such that a plurality of coding units are determined, according to an embodiment.

According to an embodiment, the image decoding apparatus 100 may determine the depth of the coding unit, based on a certain criterion. For example, the certain criterion may be the length of a long side of the coding unit. When the length of a long side of a coding unit before being split is 2n times (n>0) the length of a long side of a split current coding unit, the image decoding apparatus 100 may determine that a depth of the current coding unit is increased from a depth of the coding unit before being split, by n. In the following description, a coding unit having an increased depth is expressed as a coding unit of a lower depth.

Referring to FIG. 13, according to an embodiment, the image decoding apparatus 100 may determine a second coding unit 1302 and a third coding unit 1304 of lower depths by splitting a square first coding unit 1300 based on block shape information indicating a square shape (for example, the block shape information may be expressed as ‘0: SQUARE’). Assuming that the size of the square first coding unit 1300 is 2N×2N, the second coding unit 1302 determined by splitting a width and height of the first coding unit 1300 in ½ may have a size of N×N. Furthermore, the third coding unit 1304 determined by splitting a width and height of the second coding unit 1302 in ½ may have a size of N/2×N/2. In this case, a width and height of the third coding unit 1304 are ¼ times those of the first coding unit 1300. When a depth of the first coding unit 1300 is D, a depth of the second coding unit 1302, the width and height of which are ½ times those of the first coding unit 1300, may be D+1, and a depth of the third coding unit 1304, the width and height of which are ¼ times those of the first coding unit 1300, may be D+2.

According to an embodiment, the image decoding apparatus 100 may determine a second coding unit 1312 or 1322 and a third coding unit 1314 or 1324 of lower depths by splitting a non-square first coding unit 1310 or 1320 based on block shape information indicating a non-square shape (for example, the block shape information may be expressed as ‘1: NS_VER’ indicating a non-square shape, a height of which is longer than a width, or as ‘2: NS_HOR’ indicating a non-square shape, a width of which is longer than a height).

The image decoding apparatus 100 may determine a second coding unit 1302, 1312, or 1322 by splitting at least one of a width and height of the first coding unit 1310 having a size of N×2N. That is, the image decoding apparatus 100 may determine the second coding unit 1302 having a size of N×N or the second coding unit 1322 having a size of N×N/2 by splitting the first coding unit 1310 in a horizontal direction, or may determine the second coding unit 1312 having a size of N/2×N by splitting the first coding unit 1310 in horizontal and vertical directions.

According to an embodiment, the image decoding apparatus 100 may determine the second coding unit 1302, 1312, or 1322 by splitting at least one of a width and height of the first coding unit 1320 having a size of 2N×N. That is, the image decoding apparatus 100 may determine the second coding unit 1302 having a size of N×N or the second coding unit 1312 having a size of N/2×N by splitting the first coding unit 1320 in a vertical direction, or may determine the second coding unit 1322 having a size of N×N/2 by splitting the first coding unit 1320 in horizontal and vertical directions.

According to an embodiment, the image decoding apparatus 100 may determine a third coding unit 1304, 1314, or 1324 by splitting at least one of a width and height of the second coding unit 1302 having a size of N×N. That is, the image decoding apparatus 100 may determine the third coding unit 1304 having a size of N/2×N/2, the third coding unit 1314 having a size of N/4×N/2, or the third coding unit 1324 having a size of N/2×N/4 by splitting the second coding unit 1302 in vertical and horizontal directions.

According to an embodiment, the image decoding apparatus 100 may determine the third coding unit 1304, 1314, or 1324 by splitting at least one of a width and height of the second coding unit 1312 having a size of N/2×N. That is, the image decoding apparatus 100 may determine the third coding unit 1304 having a size of N/2×N/2 or the third coding unit 1324 having a size of N/2×N/4 by splitting the second coding unit 1312 in a horizontal direction, or may determine the third coding unit 1314 having a size of N/4×N/2 by splitting the second coding unit 1312 in vertical and horizontal directions.

According to an embodiment, the image decoding apparatus 100 may determine the third coding unit 1304, 1314, or 1324 by splitting at least one of a width and height of the second coding unit 1322 having a size of N×N/2. That is, the image decoding apparatus 100 may determine the third coding unit 1304 having a size of N/2×N/2 or the third coding unit 1314 having a size of N/4×N/2 by splitting the second coding unit 1322 in a vertical direction, or may determine the third coding unit 1324 having a size of N/2×N/4 by splitting the second coding unit 1322 in vertical and horizontal directions.

According to an embodiment, the image decoding apparatus 100 may split the square coding unit 1300, 1302, or 1304 in a horizontal or vertical direction. For example, the image decoding apparatus 100 may determine the first coding unit 1310 having a size of N×2N by splitting the first coding unit 1300 having a size of 2N×2N in a vertical direction, or may determine the first coding unit 1320 having a size of 2N×N by splitting the first coding unit 1300 in a horizontal direction. According to an embodiment, when a depth is determined based on the length of the longest side of a coding unit, a depth of a coding unit determined by splitting the first coding unit 1300 having a size of 2N×2N in a horizontal or vertical direction may be the same as the depth of the first coding unit 1300.

According to an embodiment, a width and height of the third coding unit 1314 or 1324 may be ¼ times those of the first coding unit 1310 or 1320. When a depth of the first coding unit 1310 or 1320 is D, a depth of the second coding unit 1312 or 1322, the width and height of which are ½ times those of the first coding unit 1310 or 1320, may be D+1, and a depth of the third coding unit 1314 or 1324, the width and height of which are ¼ times those of the first coding unit 1310 or 1320, may be D+2.

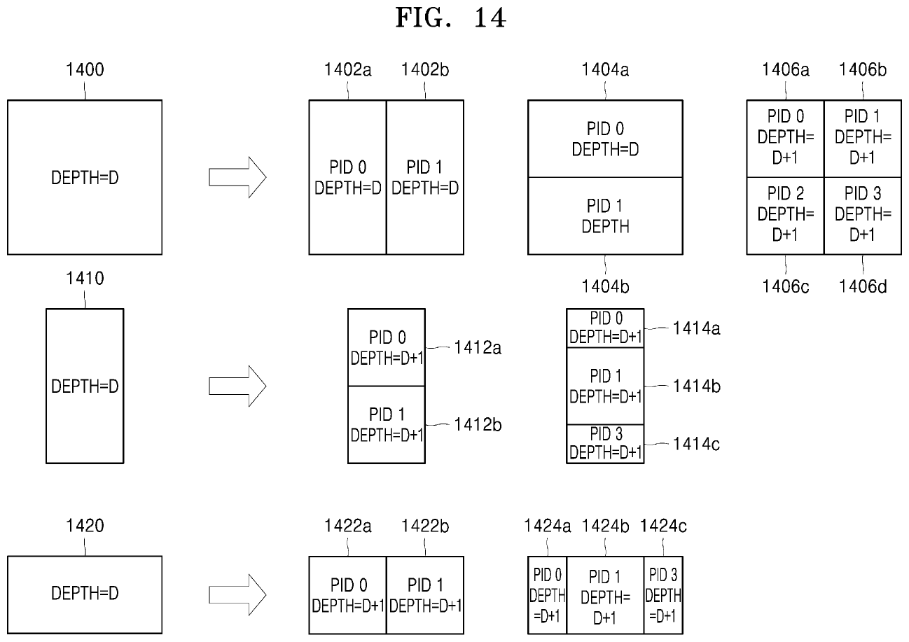

FIG. 14 illustrates depths that are determinable based on shapes and sizes of coding units, and part indexes (PIDs) that are for distinguishing the coding units, according to an embodiment.

According to an embodiment, the image decoding apparatus 100 may determine various-shape second coding units by splitting a square first coding unit 1400. Referring to FIG. 14, the image decoding apparatus 100 may determine second coding units 1402a and 1402b, 1404a and 1404b, and 1406a, 1406b, 1406c, and 1406d by splitting the first coding unit 1400 in at least one of vertical and horizontal directions based on split shape mode information. That is, the image decoding apparatus 100 may determine the second coding units 1402a and 1402b, 1404a and 1404b, and 1406a, 1406b, 1406c, and 1406d, based on the split shape mode information of the first coding unit 1400.

According to an embodiment, a depth of the second coding units 1402a and 1402b, 1404a and 1404b, and 1406a, 1406b, 1406c, and 1406d, which are determined based on the split shape mode information of the square first coding unit 1400, may be determined based on the length of a long side thereof. For example, because the length of a side of the square first coding unit 1400 equals the length of a long side of the non-square second coding units 1402a and 1402b, and 1404a and 1404b, the first coding unit 2100 and the non-square second coding units 1402a and 1402b, and 1404a and 1404b may have the same depth, e.g., D. However, when the image decoding apparatus 100 splits the first coding unit 1400 into the four square second coding units 1406a, 1406b, 1406c, and 1406d based on the split shape mode information, because the length of a side of the square second coding units 1406a, 1406b, 1406c, and 1406d is ½ times the length of a side of the first coding unit 1400, a depth of the second coding units 1406a, 1406b, 1406c, and 1406d may be D+1 which is lower than the depth D of the first coding unit 1400 by 1.

According to an embodiment, the image decoding apparatus 100 may determine a plurality of second coding units 1412a and 1412b, and 1414a, 1414b, and 1414c by splitting a first coding unit 1410, a height of which is longer than a width, in a horizontal direction based on the split shape mode information. According to an embodiment, the image decoding apparatus 100 may determine a plurality of second coding units 1422a and 1422b, and 1424a, 1424b, and 1424c by splitting a first coding unit 1420, a width of which is longer than a height, in a vertical direction based on the split shape mode information.

According to an embodiment, a depth of the second coding units 1412a and 1412b, and 1414a, 1414b, and 1414c, or 1422a and 1422b, and 1424a, 1424b, and 1424c, which are determined based on the split shape mode information of the non-square first coding unit 1410 or 1420, may be determined based on the length of a long side thereof. For example, because the length of a side of the square second coding units 1412a and 1412b is ½ times the length of a long side of the first coding unit 1410 having a non-square shape, a height of which is longer than a width, a depth of the square second coding units 1412a and 1412b is D+1 which is lower than the depth D of the non-square first coding unit 1410 by 1.

Furthermore, the image decoding apparatus 100 may split the non-square first coding unit 1410 into an odd number of second coding units 1414a, 1414b, and 1414c based on the split shape mode information. The odd number of second coding units 1414a, 1414b, and 1414c may include the non-square second coding units 1414a and 1414c and the square second coding unit 1414b. In this case, because the length of a long side of the non-square second coding units 1414a and 1414c and the length of a side of the square second coding unit 1414b are ½ times the length of a long side of the first coding unit 1410, a depth of the second coding units 1414a, 1414b, and 1414c may be D+1 which is lower than the depth D of the non-square first coding unit 1410 by 1. The image decoding apparatus 100 may determine depths of coding units split from the first coding unit 1420 having a non-square shape, a width of which is longer than a height, by using the above-described method of determining depths of coding units split from the first coding unit 1410.

According to an embodiment, the image decoding apparatus 100 may determine PIDs for identifying split coding units, based on a size ratio between the coding units when an odd number of split coding units do not have equal sizes. Referring to FIG. 14, a coding unit 1414b of a center location among an odd number of split coding units 1414a, 1414b, and 1414c may have a width equal to that of the other coding units 1414a and 1414c and a height which is two times that of the other coding units 1414a and 1414c. That is, in this case, the coding unit 1414b at the center location may include two of the other coding unit 1414a or 1414c. Therefore, when a PID of the coding unit 1414b at the center location is 1 based on a scan order, a PID of the coding unit 1414c located next to the coding unit 1414b may be increased by 2 and thus may be 3. That is, discontinuity in PID values may be present. According to an embodiment, the image decoding apparatus 100 may determine whether an odd number of split coding units do not have equal sizes, based on whether discontinuity is present in PIDs for identifying the split coding units.

According to an embodiment, the image decoding apparatus 100 may determine whether to use a specific splitting method, based on PID values for identifying a plurality of coding units determined by splitting a current coding unit. Referring to FIG. 14, the image decoding apparatus 100 may determine an even number of coding units 1412a and 1412b or an odd number of coding units 1414a, 1414b, and 1414c by splitting the first coding unit 1410 having a rectangular shape, a height of which is longer than a width. The image decoding apparatus 100 may use PIDs indicating respective coding units so as to identify respective coding units. According to an embodiment, the PID may be obtained from a sample of a certain location of each coding unit (e.g., an upper left sample).

According to an embodiment, the image decoding apparatus 100 may determine a coding unit at a certain location from among the split coding units, by using the PIDs for distinguishing the coding units. According to an embodiment, when the split shape mode information of the first coding unit 1410 having a rectangular shape, a height of which is longer than a width, indicates to split a coding unit into three coding units, the image decoding apparatus 100 may split the first coding unit 1410 into three coding units 1414a, 1414b, and 1414c. The image decoding apparatus 100 may assign a PID to each of the three coding units 1414a, 1414b, and 1414c. The image decoding apparatus 100 may compare PIDs of an odd number of split coding units to determine a coding unit at a center location from among the coding units. The image decoding apparatus 100 may determine the coding unit 1414b having a PID corresponding to a middle value among the PIDs of the coding units, as the coding unit at the center location from among the coding units determined by splitting the first coding unit 1410. According to an embodiment, the image decoding apparatus 100 may determine PIDs for distinguishing split coding units, based on a size ratio between the coding units when the split coding units do not have equal sizes. Referring to FIG. 14, the coding unit 1414b generated by splitting the first coding unit 1410 may have a width equal to that of the other coding units 1414a and 1414c and a height which is two times that of the other coding units 1414a and 1414c. In this case, when the PID of the coding unit 1414b at the center location is 1, the PID of the coding unit 1414c located next to the coding unit 1414b may be increased by 2 and thus may be 3. When the PID is not uniformly increased as described above, the image decoding apparatus 100 may determine that a coding unit is split into a plurality of coding units including a coding unit having a size different from that of the other coding units. According to an embodiment, when the split shape mode information indicates to split a coding unit into an odd number of coding units, the image decoding apparatus 100 may split a current coding unit in such a manner that a coding unit of a certain location among an odd number of coding units (e.g., a coding unit of a center location) has a size different from that of the other coding units. In this case, the image decoding apparatus 100 may determine the coding unit of the center location, which has a different size, by using PIDs of the coding units. However, the PIDs and the size or location of the coding unit of the certain location are not limited to the above-described examples, and various PIDs and various locations and sizes of coding units may be used.

According to an embodiment, the image decoding apparatus 100 may use a certain data unit where a coding unit starts to be recursively split.

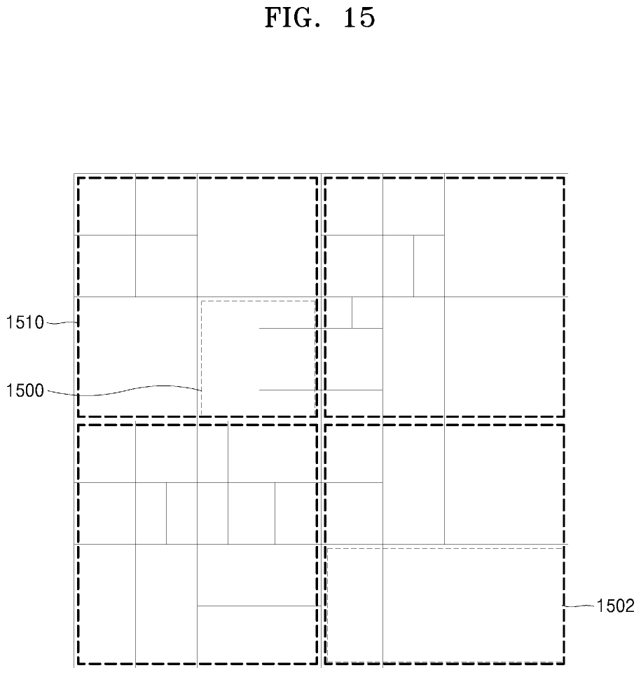

FIG. 15 illustrates that a plurality of coding units are determined based on a plurality of certain data units included in a picture, according to an embodiment.

According to an embodiment, a certain data unit may be defined as a data unit where a coding unit starts to be recursively split by using split shape mode information. That is, the certain data unit may correspond to a coding unit of an uppermost depth, which is used to determine a plurality of coding units split from a current picture. In the following descriptions, for convenience of explanation, the certain data unit is referred to as a reference data unit.

According to an embodiment, the reference data unit may have a certain size and a certain size shape. According to an embodiment, the reference data unit may include M×N samples. Herein, M and N may be equal to each other, and may be integers expressed as powers of 2. That is, the reference data unit may have a square or non-square shape, and may be split into an integer number of coding units.

According to an embodiment, the image decoding apparatus 100 may split the current picture into a plurality of reference data units. According to an embodiment, the image decoding apparatus 100 may split the plurality of reference data units, which are split from the current picture, by using the split shape mode information of each reference data unit. The operation of splitting the reference data unit may correspond to a splitting operation using a quadtree structure.

According to an embodiment, the image decoding apparatus 100 may previously determine the minimum size allowed for the reference data units included in the current picture. Accordingly, the image decoding apparatus 100 may determine various reference data units having sizes equal to or greater than the minimum size, and may determine one or more coding units by using the split shape mode information with reference to the determined reference data unit.

Referring to FIG. 15, the image decoding apparatus 100 may use a square reference coding unit 1500 or a non-square reference coding unit 1502. According to an embodiment, the shape and size of reference coding units may be determined based on various data units capable of including one or more reference coding units (e.g., sequences, pictures, slices, slice segments, tiles, tile groups, largest coding units, or the like).

According to an embodiment, the receiver 110 of the image decoding apparatus 100 may obtain, from a bitstream, at least one of reference coding unit shape information and reference coding unit size information with respect to each of the various data units. An operation of splitting the square reference coding unit 1500 into one or more coding units has been described above in relation to the operation of splitting the current coding unit 300 of FIG. 3, and an operation of splitting the non-square reference coding unit 1502 into one or more coding units has been described above in relation to the operation of splitting the current coding unit 400 or 450 of FIG. 4. Thus, detailed descriptions thereof will not be provided herein.

According to an embodiment, the image decoding apparatus 100 may use a PID for identifying the size and shape of reference coding units, to determine the size and shape of reference coding units according to some data units previously determined based on a certain condition. That is, the receiver 110 may obtain, from the bitstream, only the PID for identifying the size and shape of reference coding units with respect to each slice, slice segment, tile, tile group, or largest coding unit which is a data unit satisfying a certain condition (e.g., a data unit having a size equal to or smaller than a slice) among the various data units (e.g., sequences, pictures, slices, slice segments, tiles, tile groups, largest coding units, or the like). The image decoding apparatus 100 may determine the size and shape of reference data units with respect to each data unit, which satisfies the certain condition, by using the PID. When the reference coding unit shape information and the reference coding unit size information are obtained and used from the bitstream according to each data unit having a relatively small size, efficiency of using the bitstream may not be high, and therefore, only the PID may be obtained and used instead of directly obtaining the reference coding unit shape information and the reference coding unit size information. In this case, at least one of the size and shape of reference coding units corresponding to the PID for identifying the size and shape of reference coding units may be previously determined. That is, the image decoding apparatus 100 may determine at least one of the size and shape of reference coding units included in a data unit serving as a unit for obtaining the PID, by selecting the previously determined at least one of the size and shape of reference coding units based on the PID.

According to an embodiment, the image decoding apparatus 100 may use one or more reference coding units included in a largest coding unit. That is, a largest coding unit split from a picture may include one or more reference coding units, and coding units may be determined by recursively splitting each reference coding unit. According to an embodiment, at least one of a width and height of the largest coding unit may be integer times at least one of the width and height of the reference coding units. According to an embodiment, the size of reference coding units may be obtained by splitting the largest coding unit n times based on a quadtree structure. That is, the image decoding apparatus 100 may determine the reference coding units by splitting the largest coding unit n times based on a quadtree structure, and may split the reference coding unit based on at least one of the block shape information and the split shape mode information according to various embodiments.

According to an embodiment, the image decoding apparatus 100 may obtain block shape information indicating the shape of a current coding unit or split shape mode information indicating a splitting method of the current coding unit, from the bitstream, and may use the obtained information. The split shape mode information may be included in the bitstream related to various data units. For example, the image decoding apparatus 100 may use the split shape mode information included in a sequence parameter set, a picture parameter set, a video parameter set, a slice header, a slice segment header, a tile header, or a tile group header. Furthermore, the image decoding apparatus 100 may obtain, from the bitstream, a syntax element corresponding to the block shape information or the split shape mode information according to each largest coding unit, each reference coding unit, or each processing block, and may use the obtained syntax element.

Hereinafter, a method of determining a split rule, according to an embodiment of the present disclosure will be described in detail.

The image decoding apparatus 100 may determine a split rule of an image. The split rule may be pre-determined between the image decoding apparatus 100 and the image encoding apparatus 2200. The image decoding apparatus 100 may determine the split rule of the image, based on information obtained from a bitstream. The image decoding apparatus 100 may determine the split rule based on the information obtained from at least one of a sequence parameter set, a picture parameter set, a video parameter set, a slice header, a slice segment header, a tile header, or a tile group header. The image decoding apparatus 100 may determine the split rule differently according to frames, slices, tiles, temporal layers, largest coding units, or coding units.

The image decoding apparatus 100 may determine the split rule based on a block shape of a coding unit. The block shape may include a size, shape, a ratio of width and height, and a direction of the coding unit. The image decoding apparatus 100 may pre-determine to determine the split rule based on the block shape of the coding unit. However, an embodiment is not limited thereto. The image decoding apparatus 100 may determine the split rule of the image, based on information obtained from a received bitstream.

The shape of the coding unit may include a square and a non-square. When the lengths of the width and height of the coding unit are the same, the image decoding apparatus 100 may determine the shape of the coding unit to be a square. Also, when the lengths of the width and height of the coding unit are not the same, the image decoding apparatus 100 may determine the shape of the coding unit to be a non-square.

The size of the coding unit may include various sizes, such as 4×4, 8×4, 4×8, 8×8, 16×4, 16×8, and to 256×256. The size of the coding unit may be classified based on the length of a long side of the coding unit, the length of a short side, or the area. The image decoding apparatus 100 may apply the same split rule to coding units classified as the same group. For example, the image decoding apparatus 100 may classify coding units having the same lengths of the long sides as having the same size. Also, the image decoding apparatus 100 may apply the same split rule to coding units having the same lengths of long sides.

The ratio of the width and height of the coding unit may include 1:2, 2:1, 1:4, 4:1, 1:8, 8:1, 1:16, 16:1, 32:1, 1:32, or the like. Also, a direction of the coding unit may include a horizontal direction and a vertical direction. The horizontal direction may indicate a case in which the length of the width of the coding unit is longer than the length of the height thereof. The vertical direction may indicate a case in which the length of the width of the coding unit is shorter than the length of the height thereof.

The image decoding apparatus 100 may adaptively determine the split rule based on the size of the coding unit. The image decoding apparatus 100 may differently determine an allowable split shape mode based on the size of the coding unit. For example, the image decoding apparatus 100 may determine whether splitting is allowed based on the size of the coding unit. The image decoding apparatus 100 may determine a split direction according to the size of the coding unit. The image decoding apparatus 100 may determine an allowable split type according to the size of the coding unit.

The split rule determined based on the size of the coding unit may be a split rule pre-determined in the image decoding apparatus 100. Also, the image decoding apparatus 100 may determine the split rule based on the information obtained from the bitstream.

The image decoding apparatus 100 may adaptively determine the split rule based on a location of the coding unit. The image decoding apparatus 100 may adaptively determine the split rule based on the location of the coding unit in the image.

Also, the image decoding apparatus 100 may determine the split rule such that coding units generated via different splitting paths do not have the same block shape. However, an embodiment is not limited thereto, and the coding units generated via different splitting paths have the same block shape. The coding units generated via the different splitting paths may have different decoding process orders. Because the decoding process orders have been described above with reference to FIG. 12, details thereof are not provided again.

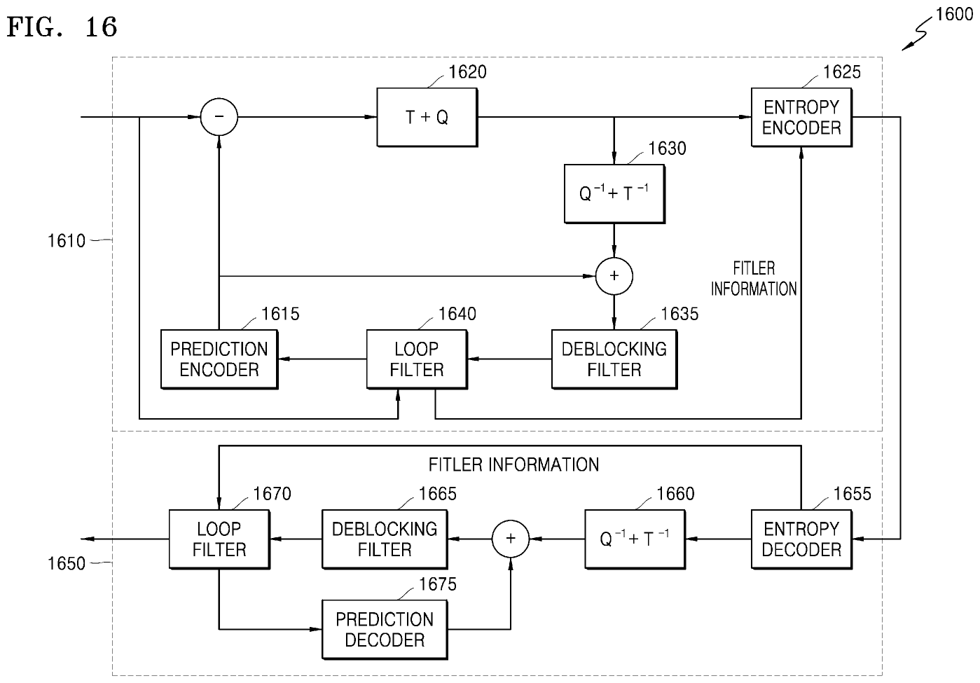

FIG. 16 is a block diagram of an image encoding and decoding system.

An encoding end 1610 of an image encoding and decoding system 1600 transmits an encoded bitstream of an image and a decoding end 1650 outputs a reconstructed image by receiving and decoding the bitstream. Here, the decoding end 1550 may have a similar configuration as the image decoding apparatus 100.

At the encoding end 1610, a prediction encoder 1615 outputs a reference image via inter-prediction and intra-prediction, and a transformer and quantizer 1620 quantizes residual data between the reference picture and a current input image to a quantized transform coefficient and outputs the quantized transform coefficient. An entropy encoder 1625 transforms the quantized transform coefficient by encoding the quantized transform coefficient, and outputs the transformed quantized transform coefficient as a bitstream. The quantized transform coefficient is reconstructed as data of a spatial domain via an inverse quantizer and inverse transformer 1630, and the data of the spatial domain is output as a reconstructed image via a deblocking filter 1635 and a loop filter 1640. The reconstructed image may be used as a reference image of a next input image via the prediction encoder 1615.

Encoded image data among the bitstream received by the decoding end 1650 is reconstructed as residual data of a spatial domain via an entropy decoder 1655 and an inverse quantizer and inverse transformer 1660. Image data of a spatial domain is configured when a reference image and residual data output from a prediction decoder 1675 are combined, and a deblocking filter 1665 and a loop filter 1670 may output a reconstructed image regarding a current original image by performing filtering on the image data of the spatial domain. The reconstructed image may be used by the prediction decoder 1675 as a reference image for a next original image.

The loop filter 1640 of the encoding end 1610 performs loop filtering by using filter information input according to a user input or system setting. The filter information used by the loop filter 1640 is output to the entropy encoder 1625 and transmitted to the decoding end 1650 together with the encoded image data. The loop filter 1670 of the decoding end 1650 may perform loop filtering based on the filter information input from the decoding end 1650.

Hereinafter, with reference to FIGS. 17 through 20, a method and an apparatus for encoding or decoding each of tiles split from a picture will be described in detail, according to an embodiment described in this specification.

FIG. 17 is a block diagram of a video decoding apparatus according to an embodiment.

Referring to FIG. 17, a video decoding apparatus 1700 according to an embodiment may include a block location determiner 1710, an inter-prediction performer 1720, and a reconstructor 1730.

The video decoding apparatus 1700 may obtain a bitstream generated as a result of encoding an image and decode motion information for inter-prediction based on information included in the bitstream.

The video decoding apparatus 1700 according to an embodiment may include a central processor (not shown) for controlling the block location determiner 1710, the inter-prediction performer 1720, and the reconstructor 1730. Alternatively, the block location determiner 1710, the inter-prediction performer 1720, and the reconstructor 1730 may operate by their own processors (not shown), and the processors may systematically operate with each other to operate the video decoding apparatus 1700. Alternatively, the block location determiner 1710, the inter-prediction performer 1720, and the reconstructor 1730 may be controlled according to control of an external processor (not shown) of the video decoding apparatus 1700.

The video decoding apparatus 1700 may include one or more data storages (not shown) storing input/output data of the block location determiner 1710, the inter-prediction performer 1720, and the reconstructor 1730. The video decoding apparatus 1700 may include a memory controller (not shown) for controlling data input and output of the data storage.

The video decoding apparatus 1700 may perform an image decoding operation including prediction by connectively operating with an internal video decoding processor or an external video decoding processor so as to reconstruct an image via image decoding. The internal video decoding processor of the video decoding apparatus 1700 according to an embodiment may perform a basic image decoding operation in a manner that not only a separate processor but also an image decoding processing module included in a central processing apparatus or a graphic processing apparatus perform the basic image decoding operation.

The video decoding apparatus 1700 may be included in the image decoding apparatus 100 described above. For example, the block location determiner 1710 may be included in the receiver 110 of the image decoding apparatus 100 of FIG. 1, and the inter-prediction performer 1720 and reconstructor 1730 may be included in the decoder 120 of the image decoding apparatus 100.

The block location determiner 1710 receives a bitstream generated as a result of encoding an image. The bitstream may include information for determining a motion vector used for inter-prediction of a current block. The current block is a block generated when an image is split according to a tree structure, and for example, may correspond to a largest coding unit, a coding unit, or a transform unit.

The block location determiner 1710 may determine the current block based on block shape information and/or information about a split shape mode, which are included in at least one of a sequence parameter set, a picture parameter set, a video parameter set, a slice header, and a slice segment header. Furthermore, the block location determiner 1710 may obtain, from the bitstream, a syntax element corresponding to the block shape information or the information about the split shape mode according to each largest coding unit, each reference coding unit, or each processing block, and may use the obtained syntax element to determine the current block.

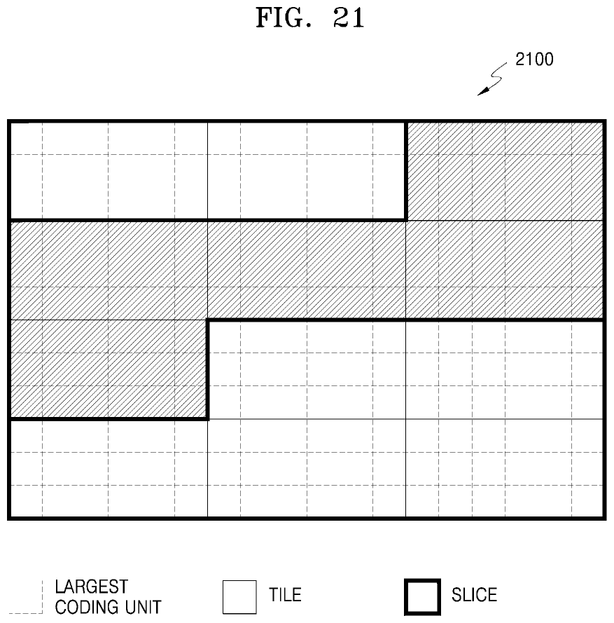

The block location determiner 1710 according to an embodiment may determine in which location of a current tile, the current block, which is to be decoded, is located. For example, the block location determiner 1710 may determine whether or not the current block is a first largest coding unit of the tile. The current tile may include a plurality of largest coding units. A picture may include a plurality of tiles. The relationship among a largest coding unit, a tile, and a picture will be described below by referring to FIG. 21.

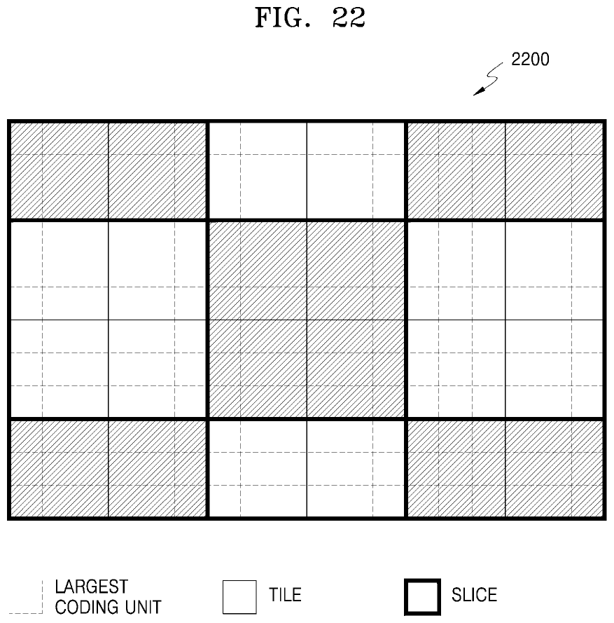

FIGS. 21 and 22 illustrate a relationship among a largest coding unit, a tile, and a slice in a tile-partitioning method according to an embodiment.

Each of a first picture 2100 of FIG. 21 and a second picture 2200 of FIG. 22 may be split into a plurality of largest coding units. Square blocks indicated by substantial lines are the largest coding units. The tiles are the square areas indicated by thin substantial lines in the first picture 2100 and the second picture 2200, and each tile includes one or more largest coding units. The square areas indicated by thick substantial lines in the first picture 2100 and the second picture 2200 are slices, and each slice includes one or more tiles.

The first picture 2100 is split into 18×12 largest coding units, 12 tiles, and 3 slices, and each slice is a group of tiles, wherein the tiles are connected in a raster-scan direction.

The second picture 2200 is split into 18×12 largest coding units, 24 tiles, and 9 slices, and each slice is a group of tiles, wherein the tiles are connected as a square shape.

A boundary of each tile corresponds to a boundary of the largest coding unit, and thus, the largest coding unit is not crossed over. The video decoding apparatus 1700 may decode the largest coding units in the tile in a raster-scan order, and there may be no data dependency between the tiles. Thus, the video decoding apparatus 1700 may not use information, such as a pixel value or a motion vector in a block of a neighboring tile, in order to decode blocks located at a boundary portion of the tile. Similarly, the video decoding apparatus 1700 may not use information, such as a pixel value or a motion vector in a block of a neighboring slice, in order to decode blocks located at a boundary portion of the slice.

Thus, neighboring tiles may be simultaneously decoded, and neighboring slices may be simultaneously decoded, to perform parallel processing. Also, bits generated in each tile are indicated by sub-bitstreams, and a starting location of each sub-bitstream is signaled through a slice header, and thus, entropy-decoding on each tile may be simultaneously performed in a parallel manner.

A slice header syntax is obtained before a slice is decoded, and thus, an additional encoding bit is generated. However, a tile requires only a syntax element to define a width and a size of the tile, and thus, may have a smaller bit rate reduction than a slice. In addition, the video decoding apparatus 1700 may obtain, from a bitstream, information about whether or not to perform deblocking filtering and in-loop filtering such as a sample adaptive offset (SAO) at a boundary of the tile.

Also, a picture may be split into one or more sub-pictures. The sub-picture may be a tile group including one or more tiles. The video decoding apparatus 1700 may obtain, from the bitstream, information about whether or not to perform in-loop filtering on a boundary of each sub-picture. The information about whether or not to perform in-loop filtering on a boundary of each sub-picture may be separately obtained for each sub-picture and may be obtained from a sequence parameter set.

The block location determiner 1710 according to an embodiment may, based on a location of a current tile, in which a current block is located, determine whether or not to perform history-based motion vector prediction for inter-prediction of the current block.

A motion vector prediction (MVP) candidate list or a merge candidate list of the inter-prediction may include motion information of a spatially neighboring block and a temporally neighboring block of the current block. In the history-based motion vector prediction technique, not only the motion information of the spatially neighboring block and the temporally neighboring block of the current block, but also motion information of a block that is encoded earlier than the current block, may be included in the motion information candidate list of the current block.

When an inter-prediction mode of the current block is a merge mode, the motion information candidate list may be the merge candidate list. When the inter-prediction mode of the current block is an advanced motion vector prediction (AMVP) mode, the motion information candidate list may be the MVP candidate list.

Thus, the video decoding apparatus 1700 may store a history motion vector prediction (hmvp) table including one or more history-based motion vector candidates. When the current block is a first block of the slice, the hmvp table may be reset. The number of candidates to be included in the hmvp table may be predetermined. In order to determine whether or not to add a new candidate to the hmvp table, the video decoding apparatus 1700 may identify redundancy between previous candidates existing in the table and a new candidate and may only add the new candidate to the hmvp table when there is no redundancy. Also, when the number of candidates to be included in the hmvp table has reached a maximum number, existing candidates stored in the hmvp table may be removed or new candidates may not be added.

When it is determined to perform the history-based motion vector prediction on the current block, the inter-prediction performer 1720 according to an embodiment may generate the motion information candidate list including the history-based motion vector candidates.

When the video decoding apparatus 1700 composes the candidates of the MVP candidate list or the merge candidate list based on the motion information of the spatially neighboring block or the temporally neighboring block, and the number of candidates of the MVP candidate list or the merge candidate list does not reach the maximum number, the video decoding apparatus 1700 may add the candidates included in the hmvp table to the MVP candidate list or the merge candidate list. However, only when there is a candidate in the hmvp table, the candidate may be added to the MVP candidate list or the merge candidate list. When there is no added candidate after the hmvp table is reset, the inter-prediction performer 1720 may determine not to perform the history-based motion vector prediction on the current block and may not perform the history-based motion vector prediction.

The inter-prediction performer 1720 may determine a motion vector of the current block by using a motion vector predictor determined from the motion information candidate list.

The reconstructor 1730 according to an embodiment may reconstruct the current block by using the motion vector of the current block. The reconstructor 1730 may determine a reference block in a reference picture by using the motion vector of the current block and may determine prediction samples corresponding to the current block from reference samples included in the reference block.

When a prediction mode of the current block is not a skip mode, the video decoding apparatus 1700 may parse transform coefficients of the current block from a bit stream and perform inverse-quantization and inverse-transform on the transform coefficients to obtain residual samples. The reconstructor 1730 may determine reconstruction samples of the current block by combining the residual samples of the current block with the prediction samples of the current block.

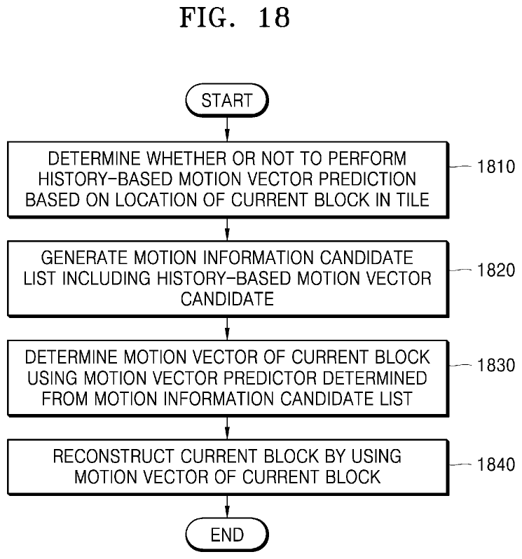

Hereinafter, a video decoding method for decoding a picture via reconstruction of each tile is described below with reference to FIG. 18.

FIG. 18 is a flowchart of a video decoding method according to an embodiment.

In operation 1810, based on a location of a tile, in which a current block is located, the tile including a plurality of largest coding units, the block location determiner 1710 may determine whether or not to perform history-based motion vector prediction for inter-prediction of the current block.

When the current block is a first block of the tile, the block location determiner 1710 according to an embodiment may reset the number of history-based motion vector candidates as 0 for inter-prediction of the current block. That is, the hmvp table may be reset.

In operation 1820, when it is determined to perform the history-based motion vector prediction on the current block, the inter-prediction performer 1720 may generate a motion information candidate list including history-based motion vector candidates.

When there is no added candidate after the hmvp table is reset, the inter-prediction performer 1720 may determine not to perform the history-based motion vector prediction on the current block and may not perform the history-based motion vector prediction.

However, when there is an added candidate after the hmvp table is reset, the inter-prediction performer 1720 may determine not to perform the history-based motion vector prediction on the current block and may not perform the history-based motion vector prediction by generating the motion information candidate list including the history-based motion vector candidates.

In operation 1830, the inter-prediction performer 1720 may determine a motion vector of the current block by using a motion vector predictor determined from the motion information candidate list.

The video decoding apparatus 1700 may obtain, from a bitstream, a candidate index of the current block, indicating one candidate from the motion information candidate list. The motion vector predictor of the current block may be determined based on a motion vector candidate indicated by the candidate index of the current block from among candidates included in the motion information candidate list, and the motion vector of the current block may be determined by using the motion vector predictor.

When an inter-prediction mode of the current block is an AMVP mode, not only a candidate index indicating one from the motion information candidate list (an AMVP candidate list), but also information indicating a prediction direction L0 or L1, a reference picture index, and motion vector differential information may be obtained. A reference picture in the direction L0 and/or the direction L1 may be determined based on the information indicating the prediction directions L0 and L1 and the reference picture index, and the motion vector in the direction L0 and/or the direction L1 may be determined based on the candidate index and the motion vector differential information.

When the inter-prediction mode of the current block is a skip mode or a merge mode, only the candidate index indicating one from a motion information candidate list (a merge candidate list) may be obtained. The motion vector predictor may be determined according to motion information of a neighboring block indicated by the candidate index, and the motion vector of the current block may be determined by using the motion vector predictor.

However, when the inter-prediction mode of the current block is a merge with motion vector difference (MMVD) mode as well as the skip mode or the merge mode, not only the candidate index, but also a distance index and a direction index of a motion vector difference may be obtained. The motion vector difference may be determined based on the distance index and the direction index of the motion vector difference, and the motion vector difference may be added to the motion vector predictor according to the candidate index to determine the motion vector of the current block.

In operation 1840, the reconstructor 1730 according to an embodiment may reconstruct the current block by using the motion vector of the current block. The reconstructor 1730 may determine a reference block in a reference picture by using the motion vector of the current block and may determine prediction samples corresponding to the current block from reference samples included in the reference block. The reconstructor 1730 may determine reconstruction samples of the current block by summing the prediction samples of the current block with the residual samples of the current block in a prediction mode except for the skip mode. When there are no residual samples like in the skip mode, the reconstruction samples of the current block may be determined by using only the prediction samples of the current block.

A picture may be split into one or more tile rows and one or more tile columns. A tile may be a square area that is split from the picture and includes one or more largest coding units. The tile may be included in the one or more tile rows and the one or more tile columns.

By reconstructing the current block, a current tile may be reconstructed, and a current picture including the current tile may be reconstructed.

The video decoding apparatus 1700 according to an embodiment may obtain information about a width of a tile column and information about a height of a tile row from tiles that are split from a picture. The video decoding apparatus 1700 according to an embodiment may determine sizes of the tiles that are split from the picture, based on the information about the width of the tile column and the information about the height of the tile row. That is, because a tile is located at each point in which a tile column and a tile row cross each other, a width of the tile column may be a width of the tile, and a height of the tile row may be a height of the tile.

According to another embodiment, the video decoding apparatus 1700 may obtain information about the number of tile columns horizontally included in the picture and information about the number of tile rows vertically included in the picture. Information about a width of each tile column may be obtained based on the number of horizontally included tile columns, and information about a height of each tile row may be obtained based on the number of vertically included tile rows.

When the picture is split into one or more tile groups, the video decoding apparatus 1700 according to an embodiment may determine whether or not to perform in-loop filtering on a boundary of the tile groups. The tile groups may be slices.

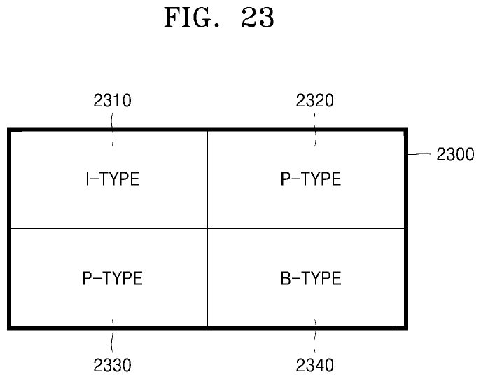

An embodiment in which the video decoding apparatus 1700 according to an embodiment determines a coding type of the tiles as one of I-type, P-type, and B-type is described in detail with reference to FIG. 23.

FIG. 23 illustrates a picture that is split into tiles of various coding types, according to an embodiment.

The video decoding apparatus 1700 may determine coding types of tile groups 2310, 2320, 2330, and 2340, as I-type, P-type, P-type, and B-type. That is, the coding type of each tile group 2310, 2320, 2330, or 2340 may be separately determined from a neighboring tile group. The tile group may be a slice including one or more tiles.

Also, even when one or more neighboring tiles are included a tile group, and a picture is split into a plurality of coding types, a coding type (type I, type P, or type B) of each tile may be separately determined from a coding type of a neighboring tile.

For each tile or each tile group, information indicating a coding type thereof may be separately obtained. The information indicating the coding type may indicate an area (I-type) including blocks performing only intra-prediction, an area (P-type) including blocks performing only inter-prediction in one direction L0 or L1, and an area (B-type) including blocks performing only inter-prediction in bi-directions L0 and L1.

Also, a random access point of each tile group 2310, 2320, 2330, or 2340 may be separately determined. For example, in a 360-degree video, etc., a random access point may be set for each tile or each tile group. Thus, in one picture 2300, a tile group (for example, an IDR tile group), for which a random access is possible, and a tile group (for example, a non-IDR tile group), for which a random access is not possible, may be mixedly present. Here, a tile in the tile group, for which a random access is possible, may be independently decoded, and a tile in the tile group, for which a random access is not possible, may be decoded by referring to another image previously decoded.

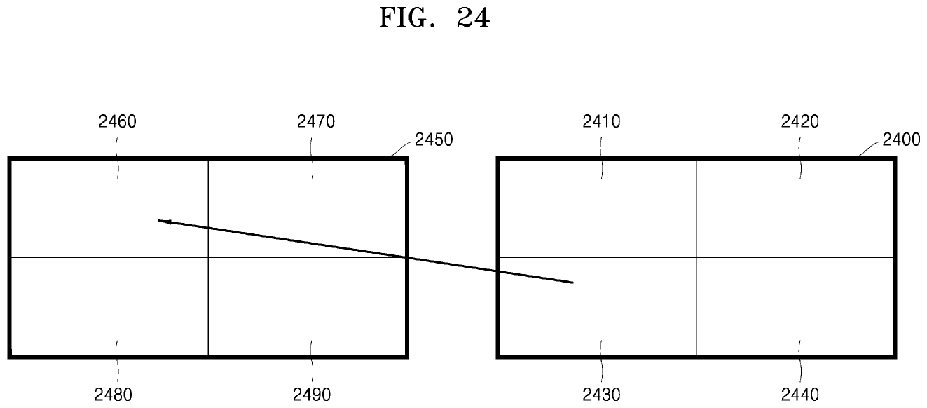

The video decoding apparatus 1700 according to an embodiment may have a motion constraint that motion reference is possible only within a temporally corresponding tile group. The motion constraint between tiles is described in detail with reference to FIG. 24.

FIG. 24 illustrates a limit range of motion compensation according to an embodiment.

A first picture 2400 may be split into tiles 2410, 2420, 2430, and 2440, and a second picture 2450 may be split into tiles 2460, 2470, 2480, and 2490. When a reference picture index of the first picture 2400 indicates the second picture 2450, a motion vector of a current tile 2430 may indicate only a block in the reference tile 2460.

Such a motion constraint between the tiles may extend to a tile group.

According to an embodiment, a first tile group may include a plurality of tiles that are adjacent to each other from among tiles split from a first picture, and a second tile group may include tiles of a second picture that correspond to locations of the plurality of tiles included in the first tile group. The first tile group may be a first slice including a first tile, and the second tile group may be a second slice including a second tile.

There may be such a motion constraint that, when a reference picture of the first tile of the plurality of tiles included in the first tile group is the first picture, the video decoding apparatus 1700 may permit a motion vector of a first block included in the first tile to indicate a block included in the tiles included in the second tile group. In this case, the video decoding apparatus 1700 may not permit the motion vector of the first block to indicate a block of the second picture, the block being outside the second tile group.

In contrast, when there is no motion constraint with respect to the permission of indicating a block included in the tiles included in the second tile group, the video decoding apparatus 1700 may permit the motion vector of the first block to indicate a block of the second picture, even when the block is located outside the second tile group.

Also, the video decoding apparatus 1700 may selectively determine a reference tile group, to which the first tile group may refer. For example, when a reference picture is split into a plurality of tile groups, information may be set for selecting one of the tile groups as a reference group of the first tile group, and a reference block indicated by a motion vector of a current block may be determined within a selected tile group.

As another example, it may be permitted to determine the motion vector in a plurality of tile groups including a tile group in the reference picture, the tile group being located to correspond to a current tile group, and a selectively added type group.

The video decoding apparatus 1700 according to an embodiment may obtain information about a current tile or a current tile group from a tile group header or a tile header.

When a motion constraint is applied to the current tile based on the obtained information, a block included in the current tile may refer to only an inner area of a tile in a reference image, the tile being in a same location as the current tile, or may refer to only an inner area of a tile having the same tile index as the current tile, if not the same location. The inter-prediction performer 1720 may also additionally signal an index of a tile to which the current tile is to refer, and the block of the current tile may refer to only an inner area of a tile corresponding to the tile index.

Similarly, when information about the current tile group indicates that a motion constraint is applied to the current tile group, the inter-prediction performer 1720 may, with respect to a block included in the current tile group, refer to only an area in a tile group in the reference image, the tile group being in the same location as the current tile group, or refer to only an inner area of a tile group having the same tile group index as the current tile group, if not the same location. The inter-prediction performer 1720 may also additionally signal an index of a tile group to which the current tile group is to refer, and the block of the current tile may refer to only an inner area of a tile corresponding to the tile group index. The tile group may be a sub-picture of the picture.

When the information about the current tile group indicates that no motion constraint is applied to the current tile, the reference picture of the current block included in the current tile group may be determined in units of a picture, rather than units of a sub-picture. Thus, an index of a current sub-picture including the current tile group may correspond to a location of a sub-picture in a current picture, and an index of a reference sub-picture including a reference block indicated by the motion vector of the current block may correspond to a location of a sub-picture in the reference picture of the current block. Even when the index of the current sub-picture and the index of the reference sub-picture are different from each other, the reference block is included in the reference picture of the current block, and thus, the reference block may be used for motion prediction.

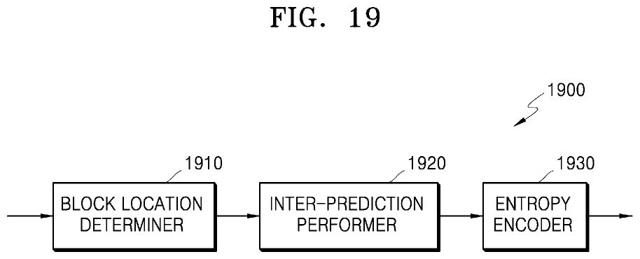

Hereinafter, a video encoding apparatus for splitting a picture into tiles and performing encoding on each tile is described below with reference to FIG. 19.

FIG. 19 is a block diagram of a video encoding apparatus according to an embodiment.

Referring to FIG. 19, a video encoding apparatus 1900 according to an embodiment may include a block location determiner 1910, and an inter-prediction performer 1920.

The video encoding apparatus 1900 may encode motion information determined by performing inter-prediction and output the encoded motion information in a form of a bitstream.

The video encoding apparatus 1900 according to an embodiment may include a central processor (not shown) for controlling the block location determiner 1910, the inter-prediction performer 1920, and an entropy encoder 1930. Alternatively, the block location determiner 1910, the inter-prediction performer 1920, and the entropy encoder 1930 may operate by their own processors (not shown), and the processors may systematically operate with each other to operate the video encoding apparatus 1900. Alternatively, the block location determiner 1910, the inter-prediction performer 1920, and the entropy encoder 1930 may be controlled according to control of an external processor (not shown) of the video encoding apparatus 1900.

The video encoding apparatus 1900 may include one or more data storages (not shown) storing input/output data of the block location determiner 1910, the inter-prediction performer 1920, and the entropy encoder 1930. The video encoding apparatus 1900 may include a memory controller (not shown) for controlling data input and output of the data storage.

The video encoding apparatus 1900 may perform an image encoding operation including prediction by connectively operating with an internal video encoding processor or an external video encoding processor so as to encode an image. The internal video encoding processor of the video encoding apparatus 1900 according to an embodiment may perform a basic image encoding operation in a manner that not only a separate processor but also an image encoding processing module included in a central processing apparatus or a graphic processing apparatus perform the basic image encoding operation.

The block location determiner 1910 according to an embodiment may, based on a location of a tile, in which a current block is located, the tile including a plurality of largest coding unit, determine whether or not to perform history-based motion vector prediction for inter-prediction of the current block.

When the current block is a first block of the tile, the block location determiner 1910 according to an embodiment may reset the number of history-based motion vector candidates as 0 for inter-prediction of the current block.

When it is determined to perform the history-based motion vector prediction on the current block, the inter-prediction performer 1920 according to an embodiment may generate a motion information candidate list including history-based motion vector candidates.

When the current block is the first block of the tile, the number of history-based motion vector candidates is reset to 0 for inter-prediction of the current block, and thus, the history-based motion vector prediction may not be performed on the current block. When there is a candidate added to an hmvp list after the number of history-based motion vector candidates is reset to 0, a motion information candidate list including the candidate of the hmvp list may be generated, and the history-based motion vector prediction may be performed.

The inter-prediction performer 1920 according to an embodiment may determine a motion vector of the current block based on a change between the current block and a reference block.

The entropy encoder 1930 according to an embodiment may encode a candidate index indicating a motion vector candidate for predicting the motion vector of the current block, from the motion information candidate list. A motion vector candidate which is most similar as the motion vector of the current may be selected from the motion information candidate list, and a candidate index indicating the selected motion vector candidate may be encoded.

When an inter-prediction mode of the current block is an AMVP mode, not only a candidate index indicating one from the motion information candidate list (an AMVP candidate list), but also information indicating a prediction direction L0 or L1, a reference picture index, and motion vector differential information may be obtained.

When the inter-prediction mode of the current block is a skip mode or a merge mode, only the candidate index indicating one from a motion information candidate list (a merge candidate list) may be encoded. However, when the inter-prediction mode of the current block is an MMVD mode as well as the skip mode or the merge mode, not only the candidate index, but also a distance index and a direction index of a motion vector difference may be encoded.

The inter-prediction performer 1920 may determine samples of a reference block indicated by the motion vector of the current block as prediction samples of the current block. The video encoding apparatus 1900 may determine the residual samples that are difference between original samples and prediction samples of the current block. The entropy encoder 1930 may encode the transform coefficients generated by performing transform and quantization on the residual samples of the current block.

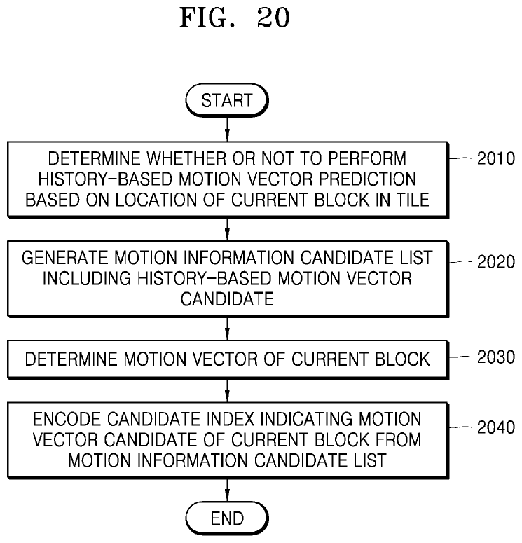

Hereinafter, a process in which the video encoding apparatus 1900 performs video encoding on a tile of a picture is described with reference to FIG. 20.

FIG. 20 is a flowchart of a video encoding method according to an embodiment.

In operation 2010, based on a location of a current block in a tile including a plurality of largest coding units, the block location determiner 1910 may determine whether or not to perform history-based motion vector prediction for inter-prediction of the current block.

The video encoding apparatus 1900 may split a picture into one or more tile rows and one or more tile columns. Each tile may be a square area that is split from the picture and includes one or more largest coding units. Each tile may be included in the one or more tile rows and the one or more tile columns.

The video encoding apparatus 1900 may determine a width and a height of each tile as fixed values. In this case, the entropy encoder 1930 may encode information about a width of a tile column and information about a height of a tile row from among the tiles split from the picture.

The video encoding apparatus 1900 may selectively determine whether or not to perform deblocking filtering or inloop-filtering, such as SAO, on a boundary of the tiles. Thus, the entropy encoder 1730 may encode information about whether or not to perform deblocking filtering or inloop-filtering, such as SAO, on a boundary of the tiles.

Also, the picture may be split into one or more sub-pictures. The sub-picture may be a tile group including one or more tiles. The video encoding apparatus 1900 may encode information about whether or not to perform in-loop filtering on a boundary of each sub-picture. The information about whether or not to perform in-loop filtering on a boundary of each sub-picture may be separately encoded for each sub-picture and may be signaled through a sequence parameter set.

According to an embodiment, when a picture is split into one or more tile groups, the video encoding apparatus 1900 may selectively determine whether or not to perform in-loop filtering on a boundary of the tile groups, and the entropy encoder 1730 may encode information about whether or not to perform in-loop filtering at the boundary of the tile groups. Here, the tile groups may be slices.

In operation 2020, when it is determined to perform the history-based motion vector prediction on the current block, the inter-prediction performer 1920 according to an embodiment may generate a motion information candidate list including history-based motion vector candidates.

In operation 2030, the inter-prediction performer 1930 may determine a motion vector of the current block. In operation 2040, the reconstructor 1940 may encode a candidate index indicating a motion vector candidate for predicting the motion vector of the current block, from the motion information candidate list.

The entropy encoder 1930 according to an embodiment may select a motion vector candidate, which is most similar as the motion vector of the current block, from the motion information candidate list, and may encode a candidate index indicating the selected motion vector candidate.

When an inter-prediction mode of the current block is an AMVP mode, not only a candidate index indicating one from the motion information candidate list (an AMVP candidate list), but also information indicating a prediction direction L0 or L1, a reference picture index, and motion vector differential information may be encoded.

When the inter-prediction mode of the current block is a skip mode or a merge mode, only the candidate index indicating one from a motion information candidate list (a merge candidate list) may be encoded. However, when the inter-prediction mode of the current block is an MMVD mode as well as the skip mode or the merge mode, not only the candidate index, but also a distance index and a direction index of a motion vector difference may be encoded.

The video encoding apparatus 1900 may determine a coding type (type I, P, or B) of each tile separately from a coding type of a neighboring tile. Also, even when the picture is split into a plurality of coding types, the coding type (type I, P, or B) of each tile group may be determined separately from a coding type of a neighboring tile group.

Information indicating a coding type may be separately encoded for each tile or each tile group.

Also, a random access point of each tile 2310, 2320, 2330, or 2340 may be separately determined. For example, in a 360-degree video, etc., tile groups in a picture may be set as a tile group for which a random access is possible (for example, an IDR tile group) or a tile group for which a random access is not possible (for example, a Non-IDR tile group).

The video encoding apparatus 1900 according to an embodiment may have a motion constraint that a motion reference is possible only within a temporally corresponding tile group. When a reference picture index of a first picture indicates a second picture, and a location corresponding to a first tile included in the first picture is a second tile of the second picture, the inter-prediction performer 1920 may perform motion estimation such that a reference block of the current block included in the first tile may be searched for within the second tile. Thus, the motion vector of the current block may also indicate only a block in the second tile.

The video encoding apparatus 1900 according to an embodiment may encode information about a current tile or a current tile group from a tile group header or a tile header.

When a motion constraint is applied to the current tile, a block included in the current tile may refer to only an inner area of a tile in a reference image, the tile being in a same location as the current tile, or may refer to only an inner area of a tile having the same tile index as the current tile, if not the same location. The inter-prediction performer 1920 may also additionally signal an index of a tile to which the current tile is to refer, and the block of the current tile may refer to only an inner area of a tile corresponding to the tile index. In this case, the information about the current tile group may be encoded to indicate that a motion constraint is applied to the current tile.

Similarly, when the information about the current tile group indicates that a motion constraint is applied to the current tile group, the inter-prediction performer 1920 may, with respect to a block included in the current tile group, refer to only an area in a tile group in the reference image, the tile group being in the same location as the current tile group, or refer to only an inner area of a tile group having the same tile group index as the current tile group, if not the same location. The inter-prediction performer 1920 may also additionally signal an index of a tile group to which the current tile group is to refer, and the block of the current tile may refer to only an inner area of a tile corresponding to the tile group index. The tile group may be a sub-picture of the picture. The information about the current tile group may be encoded to indicate that a motion constraint is applied to the current tile.

When it is indicated that no motion prediction constraint is applied to the current tile, the reference picture of the current block included in the current tile group may be determined in units of a picture, rather than units of a sub-picture. Thus, an index of a current sub-picture including the current tile group may correspond to a location of a sub-picture in a current picture, and an index of a reference sub-picture including a reference block indicated by the motion vector of the current block may correspond to a location of a sub-picture in the reference picture of the current block. Even when the index of the current sub-picture and the index of the reference sub-picture are different from each other, the reference block is included in the reference picture of the current block, and thus, the reference block may be used for motion prediction. In this case, the video encoding apparatus 1900 may encode the information about the current tile group such that the information indicates that a motion constraint is not applied to the current tile.

Such a motion constraint between the tiles may extend to the tile groups.

According to an embodiment, a first tile group may include a plurality of tiles that are adjacent to each other from among tiles split from a first picture, and a second tile group may include tiles of a second picture that correspond to locations of the plurality of tiles included in the first tile group. The first tile group may be a first slice including a first tile, and the second tile group may be a second slice including a second tile.

When a reference picture of a first block of the tiles included in the first tile group is the first picture, the video encoding apparatus 1900 may determine a reference block of the first block only within the second tile group. Thus, a motion vector of the first block in the first tile group may be permitted to indicate only a block included in the tiles included in the second tile group. That is, the video encoding apparatus 1900 may not permit the reference block of the first block included in the first tile to correspond to a block of the second picture, the block being located outside the second tile group.

In contrast, when there is no motion constraint with respect to the permission of indicating a block included in the tiles included in the second tile group, the video encoding apparatus 1900 may permit the motion vector of the first block to indicate a block of the second picture, even when the block is located outside the second tile group.

Also, the video encoding apparatus 1900 may selectively determine a reference tile group, to which the first tile group may refer. For example, when a reference picture is split into a plurality of tile groups, information may be set for selecting one of the tile groups as a reference group of the first tile group, and a reference block of the current block may be searched for within a selected tile group.

As another example, it may be permitted to determine the reference block of the current block within a plurality of tile groups including a tile group of the reference picture, the tile group being in a location corresponding to a tile group including the current block, and a selectively added tile group.

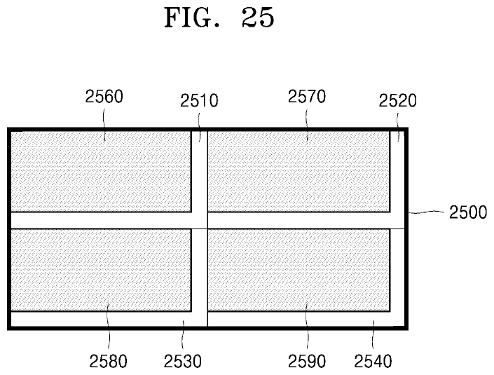

Hereinafter, various embodiments of a video decoding method using tiles and tile groups are described in detail with reference to FIGS. 25 through 28.

FIG. 25 illustrates a cropping window for each tile, according to an embodiment.

When a picture 2500 is split into tiles 2510, 2520, 2530, and 2540, the video decoding apparatus 1700 according to an embodiment may output the tiles 2510, 2520, 2530, and 2540 such that only areas corresponding to cropping windows 2560, 2570, 2580, and 2590 of the tiles 2510, 2520, 2530, and 2540, respectively, are displayed, even when the tiles 2510, 2520, 2530, and 2540 are decoded.

The video decoding apparatus 1700 according to an embodiment may set sizes of the cropping windows 2560, 2570, 2580, and 2590 of the tiles 2510, 2520, 2530, or 2540. As another example, the video decoding apparatus 1700 may set a size of the cropping windows 2560, 2570, 2580, and 2590 of the tiles 2510, 2520, 2530, and 2540 and apply the cropping windows of the same size to all tiles.

The video decoding apparatus 1700 according to an embodiment may set a size of cropping windows for each tile group. As another example, the video decoding apparatus 1700 may set a size of cropping windows of tile groups and may apply the cropping windows of the same size to all tile groups.

When a cropping window is determined for each tile, it may be set that the area of the cropping window is within a boundary of the tiles. It may be set that the cropping window extends beyond the boundary of the tiles.

When a cropping window is determined for each tile group, it may be set that the area of the cropping window is within a boundary of the tile groups. It may be set that the cropping window extends beyond the boundary of the tile groups.

Also, a location of the cropping window in the tile may be separately defined according to each tile. For example, like the cropping windows 2560, 2570, 2580, and 2590 of the tiles 2510, 2520, 2530, and 2540, each cropping window may be arranged in each tile in the same location. However, each cropping window may be arranged in each tile in a different location.

The video decoding apparatus 1700 according to an embodiment may selectively output a cropping window for each tile (tile group), even when the cropping window is set.

The video decoding apparatus 1700 according to an embodiment may output the cropping windows of neighboring tiles (tile groups) by partially or wholly connecting the cropping windows.

The video decoding apparatus 1700 according to an embodiment may consider a tile group including some tiles from among tiles that are split from a picture, as one of sub-pictures of the picture, and may decode the tile group as one picture. However, a reference picture may be accessed as the unit of one picture rather than the unit of a sub-picture. Here, the sub-picture may be a slice.

However, while a boundary line of a picture is not connected to another picture, a boundary line of a sub-picture is shared by another sub-picture, and thus, a processing method of the boundary line of the picture may be different from a processing method of the boundary line of the sub-picture.

When a sample value of an external area of the boundary line of the picture is required, a padding process indicates a method performed by the video decoding apparatus 1700 to fill the external area of the boundary line of the pixel with a virtual sample value according to a predetermined method.

The video decoding apparatus 1700 according to an embodiment may not perform a padding process on the boundary line of the sub-picture.

As another example, the video decoding apparatus 1700 may perform a padding process on the boundary line of the sub-picture by using a different method from the padding process performed on the boundary line of the picture. For example, the video decoding apparatus 1700 may determine an intra-prediction direction of an external area of the boundary line based on an average of intra-prediction directions of blocks of the sub-picture and may generate samples of the external area of the boundary line of the sub-picture in the determined intra-prediction direction by using samples within the boundary line of the sub-picture. As another example, when a size of an encoded block spanning the boundary line of the sub-picture is greater than a predetermined size, an external area of a boundary line of the block spanning the boundary line of the sub-picture may be padded in the same direction as a direction in which a block spanning the boundary line of the picture is padded.

The video decoding apparatus 1700 according to an embodiment may obtain information about deblocking filtering to be applied to a boundary between the sub-pictures, from sub-picture (tile group) syntax information. For example, when the sub-pictures are generated by splitting a center of the picture in a vertical direction, the video decoding apparatus 1700 may obtain a motion vector of a right block (a block included in a right sub-picture) adjacent to a boundary of the sub-pictures and a motion vector of a left block (a block included in a left sub-picture) adjacent to the boundary of the sub-pictures and may obtain, from the sub-picture syntax information, information for determining filtering strength and a filtering area based on the motion vectors of the blocks. Similarly, when the sub-pictures are generated by splitting a center of the picture in a horizontal direction, the video decoding apparatus 1700 may obtain a motion vector of an upper block (a block included in an upper sub-picture) adjacent to the boundary of the sub-pictures and a motion vector of a lower block (a block included in a lower sub-picture) adjacent to the boundary of the sub-pictures and may obtain, from the sub-picture syntax information, information for determining filtering strength and a filtering area based on the motion vectors of the blocks. Also, the video decoding apparatus 1700 may obtain, from the sub-picture syntax information, information about in which direction deblocking filtering is to be performed on the boundary of the sub-pictures.

Also, the video encoding apparatus 1900 may encode information for determining filtering strength and a filtering area based on motion vectors of both side blocks adjacent to the boundary of the sub-pictures and may output the information as the sub-picture syntax information. Also, the video encoding apparatus 1900 may encode information about in which direction deblocking filtering is to be performed on the boundary of the sub-pictures and output the information as the sub-picture syntax information.

When the video decoding apparatus 1700 and the video encoding apparatus 1900 according to an embodiment obtain at least one of information about filtering strength and information about a filtering direction from a left sub-picture of a current sub-picture, the video decoding apparatus 1700 and the video encoding apparatus 1900 may perform deblocking filtering on a boundary between the current sub-picture and the left sub-picture based on the obtained filtering information of the left sub-picture. Similarly, when the video decoding apparatus 1700 and the video encoding apparatus 1900 according to an embodiment obtain at least one of information about filtering strength and information about a filtering direction from an upper sub-picture of the current sub-picture, the video decoding apparatus 1700 and the video encoding apparatus 1900 may perform deblocking filtering on a boundary between the current sub-picture and the upper sub-picture based on the obtained filtering information of the upper sub-picture.

Also, the video decoding apparatus 1700 and the video encoding apparatus 1900 according to an embodiment may determine whether or not to apply deblocking filtering and inloop-filtering including an SAO applied in units of a picture to tiles. Similarly, the video decoding apparatus 1700 and the video encoding apparatus 1900 according to an embodiment may determine whether or not to apply deblocking filtering and inloop-filtering including an SAO applied in units of a picture to tile groups.

The video encoding apparatus 1900 according to an embodiment may, for each tile group (sub-picture), encode information about whether or not to perform in-loop filtering on a boundary of the tile group. The video decoding apparatus 1700 according to an embodiment may, for each tile group (sub-picture), obtain the information about whether or not to perform in-loop filtering on a boundary of the tile group, from a bitstream.

A size of the tile group according to an embodiment may always have to be greater than a size of a largest coding unit. Alternatively, the size of the tile group may be N times greater than the size of the largest coding unit (N is an integer greater than or equal to 1).

A size of the tile may be proportionate to a storage size of a motion vector. For example, when the storage size of the motion vector is 8×8, the size of the tile may be multiple numbers of 8. Also, a size of a signaling unit may also be multiple numbers of 8.

According to an embodiment, a reference picture buffer may be stored in units of a tile group. For each tile group, a tile group to be referred to may be designated. That is, an identification (ID) number indicating a tile group, which is a reference object of a current tile group, may be defined in a tile group header. Even when the current tile group and the tile group indicated by the ID number are located in different locations in a picture, the tile groups are determined as tile groups in collocated locations, and the motion vector may be determined based on the current tile group. Prediction between tile groups may be permitted in the same picture.

As another example, picture rotation information or picture flipping information may be signaled for each tile group. This may be signaled through a sequence level header or a picture level header. Affine parameter information may be signaled for each tile and modified reference tile information may be used as prediction information of a current tile or block.

For example, the number of picture order counts (POCs) may be determined as multiple numbers of the number of tile groups. In addition, when a POC of a first tile group is P, a POC of a next tile group may be set as P+1. POC information may be separately determined for each tile group.

Each tile group may have a different type of encoding tool permitted thereto. The type of encoding tool permitted for each tile group may be set in the sequence level header or set for each tile group.

The video decoding apparatus 1700 may perform multi-view video coding by using the tile groups. The multi-view coding may be performed by decoding each tile group by mapping each tile group in one view.

When a boundary of tiles corresponds to a boundary of a largest coding unit, a constraint of a method of partitioning a largest coding unit and a coding unit located in the tile at the boundary of the tiles and a constraint of a method of partitioning a largest coding unit and a coding unit located at an area except for the boundary of the tiles may be set to be the same. For example, the same constraint may be set with respect to the method of partitioning the largest coding unit and the coding unit located at the boundary of the tiles and the method of partitioning the largest coding unit and the coding unit located at the area except for the boundary of the tiles, so that pipeline processes may be performed on the largest coding units and the coding units under the same condition, regardless of whether or not the largest coding units and the coding units are located at the boundary of the tiles. Here, the constraint of the partitioning method denotes that a predetermined split method is not permitted in a predetermined condition. For example, there may be a constraint that quad-tri split is not permitted to a middle block generated by performing ternary-split.

A partitioning method may be separately determined for each tile. For example, when blocks are partitioned by using quad-tri split, binary split, and ternary split, information about the split method used for each tile group, information about a maximum size or a minimum size, which is permitted in the permitted split method, information about a depth, etc. may be set.

A constraint set including constraints with respect to one or more partitioning methods may be obtained from a sequence level header. For each tile group, an index indicating one constraint of the constraint set with respect to the partitioning methods may be obtained, and based on the constraint about a partitioning method, which is indicated by the corresponding index, blocks included in a current tile group may be partitioned. Also, for each tile group, a constraint with respect to a partitioning method, the constraint not being included in the constraint set, may be defined.

When the video decoding apparatus 1700 according to an embodiment uses a history-based encoding tool, the video decoding apparatus 1700 may use information previously used to decode a current block. Here, the history-based previous information may be separately stored for each tile or each tile group. For example, when the video decoding apparatus 1700 according to an embodiment determines a motion information candidate list of a current block by using a history-based motion vector candidate used earlier than the current block, the video decoding apparatus 1700 may determine the history-based motion vector candidate for each tile or each tile group. Thus, when the current block is a first tile among tiles, the history-based motion vector candidate may be reset.

Similarly, when the video decoding apparatus 1700 according to an embodiment decodes information by using an information occurrence probability, the video decoding apparatus 1700 may separately store probability information of previous information for each tile or each tile group, in order to use the information probability previously used to decode the current block. Thus, when the current block is a first tile among tiles, the probability information of the information may be reset.

The video decoding apparatus 1700 according to an embodiment may separately determine a size and a location of each tile, by obtaining height information, width information, and starting location information of each tile.

Compared to this, a sub-picture may be determined when a picture is split according to a predetermined split method. For example, the sub-picture may be determined via a horizontal equivalent split, a vertical equivalent split, or a quad equivalent split of the picture.

Hereinafter, partitioning methods of a picture, which may be used by the video encoding apparatus 1900 to generate tiles, are described in detail, according to another embodiment.

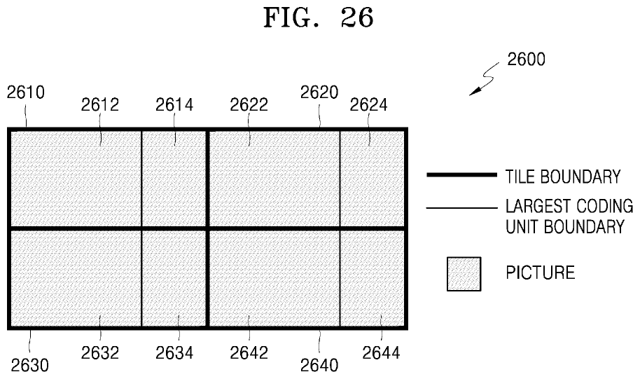

FIG. 26 illustrates a relationship between a largest coding unit and a tile, in a tile-partitioning method according to another embodiment.

The video encoding apparatus 1900 according to another embodiment may split a picture 2600 into tiles 2610, 2620, 2630, and 2640. Each of tiles 2610, 2620, 2630, and 2640 may be an area in the picture 2600. An encoded block in a current tile 2610 may not use motion information of other tiles 2620, 2630, and 2640 or information, such as reconstruction samples.

The video encoding apparatus 1900 according to an embodiment may align tiles and largest coding units such that boundaries of the tiles and the largest coding units correspond to each other. However, in FIG. 26, the boundaries of the tiles 2610, 2620, 2630, and 2640 of FIG. 26 may not be aligned with the boundaries of the largest coding units. That is, the boundary between the tiles 2610 and 2620 may vertically split a largest coding unit, so that left areas 2614 and 2634 of the largest coding units may be included in the tiles 2610 and 2630, and right areas 2622 and 2642 of the largest coding units may be included in the tiles 2620 and 2640. That is, only some areas 2612, 2632, 2642, and 2644 of the largest coding units, rather than the whole area, may be included in the tiles 2610, 2620, 2630, and 2640, respectively. However, a left boundary and an upper boundary of a left upper largest coding unit from among the largest coding units included in the tile, the left upper largest coding unit being located at a corner of the tile, may have to correspond to a left boundary and an upper boundary of the tile, respectively.

According to an embodiment, a size of the tile may be at least greater than a size of the largest coding unit. In detail, a width of the tile may be greater than or equal to a width of the largest coding unit, and a height of the tile may be greater than or equal to a height of the largest coding unit.

According to an embodiment, a minimum step size in a vertical direction and a minimum step size in a horizontal direction may be determined. The width and the height of the tile may be determined based on the minimum step size in the vertical direction and the minimum step size in the horizontal direction.

After finishing encoding the current tile, the step size may be determined based on a grid size for storing a temporal motion vector, in order to align the motion vector.

For example, the minimum step size may be N*(a grid resolution for storing the temporal motion vector). (N is an integer equal to or greater than 1).

As another example, the minimum step size may be less than the grid size for storing the motion vector. In this case, the boundary of the tile may cross a grid block for storing the temporal motion vector. The motion vector of the tile located at a corner of the grid cell may be stored as a motion vector for a grid cell. Corners of the grid cell may include a left upper corner, a right upper corner, a left lower corner, or a right lower corner.

A location of each tile may be signaled through a picture parameter set.

An X location and a Y location at a starting point of the tile may be signaled by a number indicated as a size unit of the largest coding unit. A number indicated as a minimum tile step size unit may be signaled following the number indicated as the size unit of the largest coding unit.

In FIG. 26, assuming that a minimum tile step size is 0.25 times the size of the largest coding unit, a Y location of the tile 2640 may be signaled as 1. It denotes one times the size of the largest coding unit. Next, 0 may be signaled as the minimum tile step size unit. It denotes that there is no additional number of the minimum tile step size unit. An X location of the tile 2640 may be (1.5*the size of the largest coding unit), and thus, 2 may be signaled following 1. It denotes that it is two times the size of the minimum tile step size unit, added to one times the size of the largest coding unit.

For example, the height and the width of each tile may be signaled through a header. Alternatively, after all tiles are signaled by expanding each tile until it contacts a neighboring tile, the height and the width of each tile may be implicitly determined.

For example, the video decoding apparatus 1700 may obtain information for indicating one of previously used tile partitioning methods from a picture parameter set, in order to decode a current picture. As another example, the video decoding apparatus 1700 may obtain information for indicating one of previously used tile partitioning methods, an offset in a horizontal direction, and an offset in a vertical direction, from a picture parameter set, in order to decode a current picture.

For example, size information of a current tile from among tiles included in a picture may not be obtained, and a size of the current tile may be determined by referring to a size of a tile previously signaled from among the tiles included in the picture.

For example, absolute location information of a starting point of a current tile from among tiles included in a picture may not be obtained, and a starting location of the current tile may be determined by referring to a starting location of a tile previously signaled from among the tiles included in the picture. As another example, a starting location of a current tile may be determined by referring to an edge or a corner (a left upper or right upper corner) of a tile previously signaled from among the tiles included in the picture.

As another example, the current tile may be decoded by using some information of other tiles. For example, while motion vector information of the current tile may not be determined by using motion vector information of a neighboring tile, a motion prediction mode of the current tile may be determined based on a motion prediction mode of the neighboring tile.

When all pictures included in one sequence use the same tile partitioning method, information about the tile partitioning method may be signaled once in a sequence parameter set and may not be defined again for each picture. The signaled information about the tile partitioning method may include information about a location and a size of the tile. In contrast, information about a tile partitioning method which may be changed for each picture may be signaled in a picture parameter set.

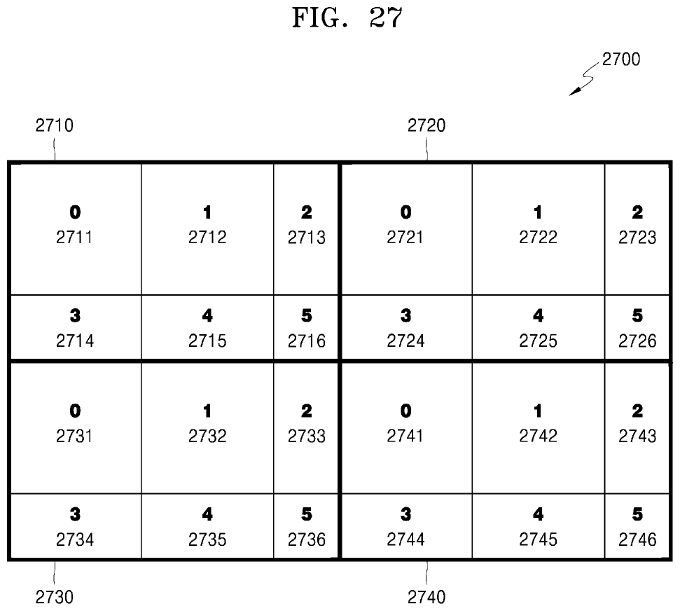

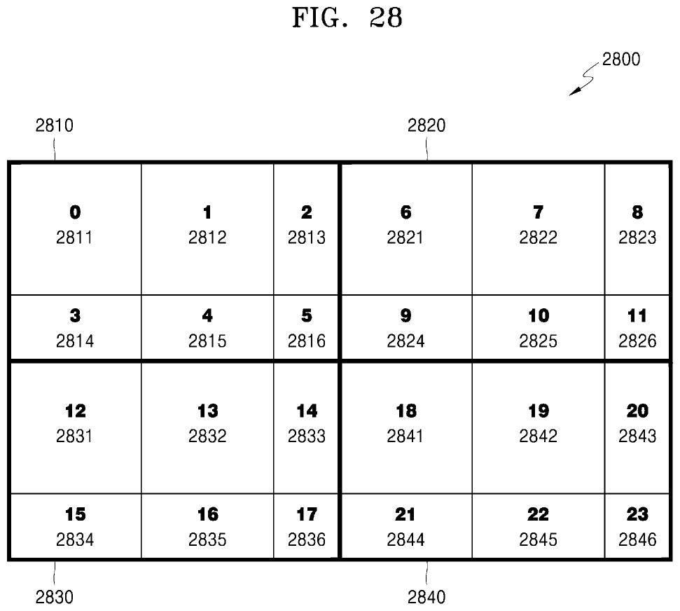

FIGS. 27 and 28 illustrate a method of allocating addresses to largest coding units included in tiles, in a tile partitioning method according to another embodiment.

Addresses of the largest coding units may be differently assigned for each tile group. In FIG. 27, a picture 2700 may be split into tile groups 2710, 2720, 2730, and 2740, and addresses of largest coding units in the tile groups 2710, 2720, 2730, and 2740 may be assigned in a raster scan order. That is, addresses of largest coding units 2711, 2712, 2713, 2714, 2715, and 2716 may be assigned as 0, 1, 2, 3, 4, and 5, respectively, according to the raster scan order in the tile group 2710. Similarly, addresses of largest coding units 2721, 2722, 2723, 2724, 2725, and 2726 may be assigned as 0, 1, 2, 3, 4, and 5, respectively, according to the raster scan order in the tile group 2720, addresses of largest coding units 2731, 2732, 2733, 2734, 2735, and 2736 may be assigned as 0, 1, 2, 3, 4, and 5, respectively, in the tile group 2730, and addresses of largest coding units 2741, 2742, 2743, 2744, 2745, and 2746 may be assigned as 0, 1, 2, 3, 4, and 5, respectively, in the tile group 2740.

An order of the tile groups 2710, 2720, 2730, and 2740 may also be determined according to the raster scan order. A number of a tile may be determined according to a pixel location, and a number of a largest coding unit may be determined based on a relative pixel location in the tile group.

As another example, addresses of the largest coding units may be continually assigned according to the order of the tile groups. In FIG. 28, a picture 2800 may be split into tile groups 2810, 2820, 2830, and 2840, and addresses of largest coding units in the tile groups 2810, 2820, 2780, and 2780 may be assigned in a raster scan order. An order of the tile groups 2810, 2820, 2830, and 2840 may also be determined according to the raster scan order. Also, because the addresses of the largest coding units are continually assigned according to the order of the tile groups, addresses of the largest coding units 2811, 2812, 2813, 2814, 2815, 2816, 2821, 2822, 2823, 2824, 2825, 2826, 2831, 2832, 2833, 2834, 2835, 2836, 2841, 2842, 2843, 2844, 2845, and 2846 may be assigned as 0, 1, 2, . . . , 21, 22, and 23, respectively, according to the raster scan order in the tile groups 2810, 2820, 2830, and 2840.

In FIGS. 27 and 28, the scan order proceeds from a left upper side to a right lower side. However, the scan order may be different, for example, from a right upper side to a left lower side, the left lower side to the right upper side, or the right lower side to the left upper side. For example, when a reference sample exists in a right tile group, the scan direction may expand according to a location of the reference sample.

Hereinafter, an example in which the video decoding apparatus 1700 and the video encoding apparatus 1900 signal information about a tile through a tile parameter set (TPS), is described in detail.

Information which may be used for decoding a tile or a plurality of tiles may be referred to as a TPS. For example, the TPS may include information, such as a maximum size of a coding unit defined in a tile or a plurality of tiles, a minimum size of the coding unit, a quantization parameter, a maximum partitioning depth, a minimum partitioning depth, a partitioning rule of a coding unit, a coding tool signaled in a coding unit or a largest coding unit, etc.

The video decoding apparatus 1700 according to an embodiment may store information obtained from the TPS in a memory and, before obtaining, from a next picture parameter set, information that there is a new TPS, may use the information of the TPS pre-stored in the memory. When the information that there is a new TPS is obtained from the picture parameter set, the video decoding apparatus 1700 may determine whether or not to reset previous information stored in the memory.

When information about a tile of the TPS is once stored, compensation information based on the previously stored information about the tile may be obtained from other picture parameter sets, and new information which may be interpreted based on the compensation information may be obtained.

The video decoding apparatus 1700 according to an embodiment may store a TPS having an ID number for each version of a decoding processor or a unique ID number. For example, when a plurality of TPSs, such as TPS-v1, TPS-v2, or the like, are stored in the video decoding apparatus 1700, a tile or a tile group having an ID number for each version or a unique ID number may be signaled and may be used to decode other tiles.

Hereinafter, an embodiment in which intra-prediction is performed in a tile group is described in detail.

A largest coding unit may be generated in a picture or a tile, the largest coding unit not having a maximum size of coding units. With respect to this largest coding unit, a block partitioning condition and a picture boundary line condition, applied to a largest coding unit located at a picture boundary line and not having a largest coding unit size, may be applied.

A case in which a tile or a tile group is applied to an intra-coding-type picture is assumed.

When a current tile or tile group is not a first tile of the picture, it may be determined whether or not to decode the current tile or tile group by using an intra-prediction mode of a neighboring or previously encoded tile or tile group or using information of a reconstruction sample.

When constructing an intra-prediction mode list, such as a most probable mode (MPM) list, it may be determined whether or not to determine a list of intra-prediction modes or history modes having a high frequency in a tile or a tile group.

There may be a constraint that a line of a block located at an upper area of a largest coding unit may not be used as a reference line of the largest coding unit or only one line of the upper block may be referred to. Similarly, a constraint may be set, whereby, between tiles included in an intra-coding type picture, a line of a tile located at an upper area may not be referred to or only a first line of the upper tile may be used for predicting a current tile.

Also, a sample value of a boundary area of a tile, in which there is no reference sample, may be padded as 0 or as a sample value of other areas.

Hereinafter, an embodiment in which various parameters are defined through a tile header or a tile group header is described in detail.

An adaptive loop filter (ALF) parameter may be signaled through the tile group header. Each tile included in a tile group may use the ALF parameter, or may use an offset signaled for each tile to apply the offset to the ALF parameter to update the ALF parameter.

According to an embodiment, whether or not a current tile is a motion constraint tile may be signaled through the tile group header or the tile header. When the current tile is a motion constraint tile, the current tile may refer to only an inner area of a tile of a reference image, the tile being in the same location as the current tile, or may refer to only an inner area in a tile having the same tile index as the current tile, if not the same location. An index of a tile to which the current tile is to refer may be additionally signaled, and the current tile may refer to only an inner area of a tile corresponding to the tile index.

According to an embodiment, there may be two methods of constructing tiles in a picture into tile groups. Each tile may be assigned with two tile group ID numbers or two mapping relationships, in which the tile is constructed into a tile group. Here, one tile group may not refer to other tile groups so that each tile group may be independently decoded. Information of another tile group may be included in a bitstream, and a NAL unit may be formed in units of a tile group and the bitstream may be decoded. Thus, the video decoding apparatus 1700 may decode the bitstream according to an order of the tiles constructed through information about a second tile group, while whether or not to predict a current tile by referring to a neighboring tile may be determined according to information about a first tile group.

Meanwhile, the embodiments of the present disclosure described above may be written as computer-executable programs that may be stored in a medium.

The medium may continuously store the computer-executable programs, or temporarily store the computer-executable programs or instructions for execution or downloading. Also, the medium may be any one of various recording media or storage media in which a single piece or plurality of pieces of hardware are combined, and the medium is not limited to a medium directly connected to a computer system, but may be distributed on a network. Examples of the medium include magnetic media, such as a hard disk, a floppy disk, and a magnetic tape, optical recording media, such as CD-ROM and DVD, magneto-optical media such as a floptical disk, and ROM, RAM, and a flash memory, which are configured to store program instructions. Other examples of the medium include recording media and storage media managed by application stores distributing applications or by websites, servers, and the like supplying or distributing other various types of software.

While one or more embodiments of the present disclosure have been described with reference to the figures, it will be understood by those of ordinary skill in the art that various changes in form and details may be made therein without departing from the spirit and scope as defined by the following claims.

1. A video decoding method comprising:
determining whether or not to perform history-based motion vector prediction for inter-prediction of a current block, based on a location of the current block in a tile including a plurality of largest coding units;
when it is determined to perform the history-based motion vector prediction on the current block, generating a motion information candidate list including history-based motion vector candidates;
determining a motion vector of the current block by using a motion vector predictor determined from the motion information candidate list; and
reconstructing the current block by using the motion vector of the current block.

2. The video decoding method of claim 1, wherein a picture is split into one or more tile rows and one or more tile columns,
the tile is a square area including one or more largest coding units split from the picture, and
the tile is included in the one or more tile rows and the one or more tile columns.

3. The video decoding method of claim 2, wherein, when the current block is a first block of the tile, a number of history-based motion vector candidates for the inter-prediction of the current block is reset to 0.

4. The video decoding method of claim 2, wherein a first tile group comprises a plurality of neighboring tiles from among tiles split from a first picture, and a second tile group comprises tiles of a second picture, the tiles corresponding to locations of the tiles included in the first tile group, and
when a motion constraint is applied to the first tile group, when a reference picture of a first tile from among the tiles included in the first tile group is the second picture, a motion vector of the first tile indicates a block included in the tiles included in the second tile group and is not permitted to indicate a block of the second picture, the block being located outside the second tile group.

5. The video decoding method of claim 2, wherein a first tile group comprises a plurality of neighboring tiles from among tiles split from a first picture, and a second tile group comprises tiles of a second picture, the tiles corresponding to locations of the tiles included in the first tile group, and
when a motion constraint is not applied to the first tile group, a motion vector of a first tile is permitted to indicate a block of the second picture, the block being located outside the second tile group.

6. The video decoding method of claim 2, wherein the picture is split into one or more tile groups, and whether or not to perform in-loop filtering on a boundary of the one or more tile groups is determined.

7. The video decoding method of claim 2, wherein coding types of tiles split from the picture are one of I-type, P-type, and B-type, and the coding types of the tiles are independently determined, and
a tile group randomly accessible and a tile group not randomly accessible are separately determined from among the tiles.

8. A video decoding apparatus comprising:
a block location determiner configured to determine whether or not to perform history-based motion vector prediction for inter-prediction of a current block, based on a location of the current block in a tile including a plurality of largest coding units;
an inter-prediction performer configured to generate a motion information candidate list including history-based motion vector candidates, when it is determined to perform the history-based motion vector prediction on the current block, and configured to determine a motion vector of the current block by using a motion vector predictor determined from the motion information candidate list; and
a reconstructor configured to reconstruct the current block by using the motion vector of the current block.

9. The video decoding apparatus of claim 8, wherein a first tile group comprises a plurality of neighboring tiles from among tiles split from a first picture, and a second tile group comprises tiles of a second picture, the tiles corresponding to locations of the tiles included in the first tile group,
when a motion constraint is applied to the first tile group, when a reference picture of a first tile from among the tiles included in the first tile group is the second picture, a motion vector of the first tile indicates a block included in the tiles included in the second tile group and is not permitted to indicate a block of the second picture, the block being located outside the second tile group, and
when the motion constraint is not applied to the first tile group,
the motion vector of the first tile is permitted to indicate the block of the second picture, the block being located outside the second tile group.

10. The video decoding apparatus of claim 8, wherein a picture is split into one or more tile groups, and whether or not to perform in-loop filtering on a boundary of the one or more tile groups is determined.

11. The video decoding apparatus of claim 8, wherein a picture is split into a plurality of tiles including the current tile,
coding types of the tiles split from the picture are one of I-type, P-type, and B-type, and the coding types of the tiles are independently determined, and
a tile group for which a random-access point is possible and a tile group for which a random-access point is not possible are separately determined from among the tiles.

12. A video encoding method comprising:
determining whether or not to perform history-based motion vector prediction for inter-prediction of a current block, based on a location of the current block in a tile including a plurality of largest coding units;
when it is determined to perform the history-based motion vector prediction on the current block, generating a motion information candidate list including history-based motion vector candidates;
determining a motion vector of the current block; and
encoding a candidate index indicating a motion vector candidate for predicting the motion vector of the current block, from the motion information candidate list.

13. The video encoding method of claim 12, wherein a first tile group comprises a plurality of neighboring tiles from among tiles split from a first picture, and a second tile group comprises tiles of a second picture, the tiles corresponding to locations of the tiles included in the first tile group, and
when a motion constraint is applied to the first tile group, when a reference picture of a first tile from among the tiles included in the first tile group is the second picture, a motion vector of the first tile indicates a block included in the tiles included in the second tile group and is not permitted to indicate a block of the second picture, the block being located outside the second tile group, and
when the motion constraint is not applied to the first tile group, the motion vector of the first tile is permitted to indicate the block of the second picture, the block being located outside the second tile group.

14. The video encoding method of claim 12, wherein a picture is split into a plurality of tiles including the current tile,
coding types of the tiles split from the picture are one of I-type, P-type, and B-type, and the coding types of the tiles are independently determined, and
a tile group for which a random-access point is possible and a tile group for which a random-access point is not possible are separately determined from among the tiles.

15. (canceled)
